(19) United States
(12) Patent Application Publication
(10) Pub. No.: US 2025/0340156 A1
(43) Pub. Date: Nov. 6, 2025

(54) ADJUSTMENT MECHANISM FOR ISOFIX CONNECTOR, SAFETY SEAT BASE, AND SAFETY SEAT

(71) Applicant: WONDERLAND SWITZERLAND AG, Steinhausen (CH)

(72) Inventor: Manqun CHENG, Dongguan, Guangdong (CN)

(73) Assignee: WONDERLAND SWITZERLAND AG, Steinhausen (CH)

(21) Appl. No.: 18/865,131

(22) PCT Filed: May 15, 2023
(86) PCT No.: PCT/EP2023/062921

§ 371 Date: Nov. 12, 2024

(30) Foreign Application Priority Data
May 13, 2022 (CN) 202210524222.8
Jan. 6, 2023 (CN) 202310020439.X
Jan. 6, 2023 (CN) 202310020458.2

(51) Int. Cl. B60N 2/28

(52) U.S. Cl. CPC B60N 2/2887; B60N 2/2869

(57) ABSTRACT

A safety seat base includes a mounting base, a rotary plate, an engaging mechanism, and a linkage mechanism. The rotary plate is rotatably arranged on the mounting base and has a first rotation position and a second rotation position. The engaging mechanism is configured to engage the rotary plate with the safety seat body. The linkage mechanism includes a driving member and a sliding member. The driving member is slidably arranged on the mounting base. The sliding member is slidably arranged on the rotary plate. The sliding member at least partially protrudes into the mounting base to abut against the driving member, or the driving member at least partially protrudes into the rotary plate to abut against the sliding member. When the rotary plate is in the first rotation position, the driving member is operable to move and drive the engaging mechanism to be unlocked.

### TECHNICAL FIELD

The present disclosure relates generally to child carriers, and in particular, to an adjustment mechanism for an ISOFIX connector, a safety seat base, and a safety seat.

### BACKGROUND

Some safety seat bases currently available on the market can often be engaged with both an infant safety seat and a child safety seat. The child safety seat is generally rotatably engaged with a vehicle seat base to be rotated for forward-facing use or rear-facing use as required, while the infant safety seat can only be rotated for rear-facing use.

In addition, the safety seat may be mounted on a vehicle through an ISOFIX system. The ISOFIX system generally includes a connector such as an ISOFIX connecting rod arranged on the safety seat and an anchor such as an ISOFIX snap ring arranged on the vehicle. In order to adapt to different vehicle models and adjust an angle of the safety seat, the safety seat is provided with an adjustment mechanism for controlling an ISOFIX connector to extend out of or retract into the bottom of the safety seat. The adjustment mechanism is generally arranged as a multi-stage adjustment structure to facilitate the user to adjust a distance between the safety seat and the ISOFIX connector during mounting the safety seat. In a known safety seat, operating members for operating the adjustment mechanism, such as operation keys, are arranged on two sides of the bottom of the safety seat, so that the user can press the operating member on either side of the safety seat to unlock the adjustment mechanism, enabling the user to adjust the distance between the safety seat and the ISOFIX connector. When the user stops operating the operating member by releasing the operating member, the adjustment mechanism can be self-locked to lock the ISOFIX connector at a target position.

### SUMMARY

According to various embodiments of the present disclosure, an adjustment mechanism for an ISOFIX connector, a safety seat base, and a safety seat are provided.

According to an aspect of the present disclosure, a safety seat base is provided. A safety seat body is mounted to the safety seat base, and the safety seat base includes: a mounting base;

a rotary plate rotatably arranged on the mounting base and having a first rotation position and a second rotation position;

an engaging mechanism configured to engage the rotary plate with the safety seat body; and

a linkage mechanism including a driving member slidably arranged on the mounting base, and a sliding member slidably arranged on the rotary plate;

wherein the sliding member at least partially protrudes into the mounting base to abut against the driving member, or the driving member at least partially protrudes into the rotary plate to abut against the sliding member; and when the rotary plate rotates to the first rotation position, the driving member is operable to move and drive the sliding member to slide, so as to drive the engaging mechanism to be unlocked.

According to another aspect of the present disclosure, a safety seat is provided, the safety seat including a safety seat body and the safety seat base as described above. The safety seat body is an infant safety seat body or a child safety seat body.

According to yet another aspect of the present disclosure, an adjustment mechanism for an ISOFIX connector is provided, the ISOFIX connector being adapted for being attached to a connection component in a vehicle adapted to the ISOFIX connector. The adjustment mechanism includes: a support configured to be connected to a base of a safety seat; a sliding rod assembly, including two sliding rods, one end of each of the two sliding rods being slidably connected to the support and releasably locked with respect to the support, the other end of each of the two sliding rods being connected to the ISOFIX connector; an adjustment assembly including a linkage and two engaging members, the two engaging members being movably connected to the linkage, the linkage being adapted to drive one of the two engaging members driven by the other of the two engaging members, so that the two engaging members move synchronously to lock the sliding rod assembly to the support or release the sliding rod assembly from the support; and an operating portion configured to drive either of the two engaging members, so that the two engaging members synchronously release the sliding rod assembly from the support or lock the sliding rod assembly to the support.

According to still another aspect of the present disclosure, a safety seat is provided, the safety seat including a base and the adjustment mechanism as described above. The base is connected to the support.

### BRIEF DESCRIPTION OF THE DRAWINGS

The following description of the illustrative embodiments may be better understood when read in conjunction with the appended drawings. It is understood that potential embodiments of the disclosed systems and methods are not limited to those depicted.

FIG. 1 is a perspective view of a safety seat according to an embodiment of the present disclosure.

FIG. 2 is a perspective view of a safety seat base of the safety seat of FIG. 1, with a rotary plate in a first rotation position.

FIG. 3 is a perspective view of the safety seat base of the safety seat of FIG. 1, with the rotary plate in a second rotation position.

FIG. 4 is a side view of the safety seat base of FIG. 2.

FIG. 5 is a perspective view of the safety seat base of FIG. 2 with an upper cover removed, a locking hook in a closed position, and a sliding member in a locked position.

FIG. 6 is an enlarged perspective view of a portion A in FIG. 5.

FIG. 7 is a side cross-sectional view of the safety seat base of FIG. 5.

FIG. 8 is an enlarged view of a portion B in FIG. 7.

FIG. 9 is a perspective view of the safety seat base of FIG. 2 with the upper cover removed, the locking hook in a releasing position, and the sliding member in an unlocked position.

FIG. 10 is an enlarged perspective view of a portion C in FIG. 9.

FIG. 11 is a side cross-sectional view of the safety seat base of FIG. 9.

FIG. 12 is an enlarged view of a portion D in FIG. 11.

FIG. 13 is a perspective view of a portion of the safety seat base of FIG. 9.

FIG. 14 is an enlarged perspective view of a portion E in FIG. 13.

FIG. 15 is a perspective view of the safety seat base of FIG. 9 with a second fixed plate removed.

FIG. 16 is an enlarged perspective view of a portion F in FIG. 15.

FIG. 17 is a side cross-sectional view of the safety seat base of the safety seat of FIG. 1, with the rotary plate in the second rotation position.

FIG. 18 is an enlarged view of a portion G in FIG. 17.

FIG. 19 is a side cross-sectional view of the safety seat base of FIG. 2, with the locking hook in the closed position and the sliding member in the locked position.

FIG. 20 is an enlarged view of a portion H in FIG. 19.

FIG. 21 is a side cross-sectional view of the safety seat base of FIG. 2, with the locking hook in the closed position and the sliding member in the locked position.

FIG. 22 is an enlarged view of a portion I in FIG. 21.

FIG. 23 is a side cross-sectional view of the safety seat base of FIG. 2, with the locking hook in the releasing position and the sliding member in the unlocked position.

FIG. 24 is an enlarged view of a portion J in FIG. 23;

FIG. 25 is a side cross-sectional view of the safety seat base of FIG. 2, with the locking hook in the releasing position and the sliding member in the unlocked position.

FIG. 26 is an enlarged view of a portion K in FIG. 25.

FIG. 27 is a side cross-sectional view of the safety seat base of FIG. 2 according to another example, with the rotary plate in the first rotation position and the sliding member in the locked position.

FIG. 28 is an enlarged view of a portion L in FIG. 27.

FIG. 29 is a side cross-sectional view of the safety seat base of FIG. 27, with the sliding member in the unlocked position.

FIG. 30 is an enlarged view of a portion M in FIG. 29.

FIG. 31 is a side cross-sectional view of the safety seat base of FIG. 3, with the rotary plate in the second rotation position and the sliding member is in the locked position.

FIG. 32 is a perspective view of the safety seat base of FIG. 2 with the rotary plate removed.

FIG. 33 is an enlarged perspective view of a portion N in FIG. 32.

FIG. 34 is a perspective view of an operating member shown in FIG. 28.

FIG. 35 is a perspective view the safety seat base of FIG. 2 with the rotary plate removed.

FIG. 36 is an enlarged perspective view of a portion O in FIG. 35.

FIG. 37 is a perspective view of a mounting base of the safety seat base of FIG. 27.

FIG. 38 is an enlarged view of a portion P in FIG. 37.

FIG. 39 is a perspective view of a portion of the safety seat base of FIG. 2.

FIG. 40 is an enlarged view of a portion Q in FIG. 39.

FIG. 41 is a perspective view of the safety seat base of FIG. 2 having an adjustment mechanism according to some embodiment, with the rotary plate removed.

FIG. 42 is an enlarged perspective view of a portion R in FIG. 41.

FIG. 43 is a perspective view of a sliding rod assembly according to some embodiment of the present disclosure.

FIG. 44 is a cross-sectional view of the safety seat base having the adjustment mechanism according to some embodiment of the present disclosure.

FIG. 45 is a perspective view of a first operating member/a second operating member according to some embodiment of the present disclosure.

FIG. 46 is a perspective view of a portion of the safety seat base, showing the sliding rod assembly of the adjustment mechanism is locked to a support according to some embodiment of the present disclosure.

FIG. 47 is a perspective view of a portion of the safety seat base, showing the sliding rod assembly of the adjustment mechanism is unlocked from the support according some an embodiment of the present disclosure.

FIG. 48 is a perspective view of a portion of the safety seat base, showing a case where the safety seat base is at a certain distance from an ISOFIX connector according to some embodiment of the present disclosure.

FIG. 49 is a perspective view of a portion of the safety seat base, showing a case where the safety seat base is at another distance, which is different from the distance shown in FIG. 48, from the ISOFIX connector according to some embodiment of the present disclosure.

### ILLUSTRATION FOR REFERENCE SIGNS

1. safety seat base, 100. engaging mechanism, 110. locking hook, 111. hook portion, 112. locking groove, 113. first pivot shaft, 114. second connecting portion, 115, first pushing portion, 116, second pushing portion, 120. fixed member, 130. third reset member, 140. stopper, 141. protruding portion, 142. second pivot shaft, 150. fourth reset member, 200\200′. linkage mechanism, 210\210′. sliding member, 211. blocking portion, 211a. pushing slope, 211b. engaging rib, 212. transmission rib, 212′. first pushing groove, 213\213′. push convex, 214. fixed hook, 220\220′. second reset member, 230\230′. driving member, 231\231′. second pushing groove, 240. reinforcing pin, 240′. linkage member, 241′. first end, 242′. second end, 250\250′. fifth reset member, 300. operating assembly, 310. operating member, 311. operating portion, 312. pivot portion, 313. first connecting portion, 320. pulling member, 340. sixth reset member, 400. indication mechanism, 410. detector, 411. detection rib, 412. pushing slope, 420. first reset member, 430. sensor, 431. transmitting end, 432. receiving end, 101. mounting base, 101a. display screen, 102. rotary plate, 103. engaging groove, 104. fixed assembly, 104a. first fixed plate, 104b. second fixed plate, 104c. rivet, 105. guiding member, 106. mounting receptacle, 107. mounting rib, 108. upper cover, 108a. fixed column, 109. lower cover, 2. safety seat body, S2. ISOFIX connector; S10. adjustment mechanism; S201. base lower cover; S2011. mounting cavity; S2012. mounting port; S100. support; S110. mounting rack; S110a. mounting rack; S110b. mounting rack; S111. first engaging hole; S120. sliding sleeve; S200. sliding rod assembly; S210. sliding rod; S210a. first sliding rod; S210b. second sliding rod; S211. second engaging hole; S220. connector; S300. adjustment assembly; S310. engaging member; S310a. first engaging member; S310b. second engaging member; S311. first meshing portion; S312 .engaging portion; S320. linkage; S321. second meshing portion; S400. operating portion; S410. operating member; S410a. first operating member; S410b. second operating member; S411. operating end; S412. pulling end; S413. pivot axis; S500. elastic member; S600. elastic reset member; S700. pulling member; S800. steering post; S900. rolling member.

### DETAILED DESCRIPTION OF THE EMBODIMENTS

In order to make the objects, technical solutions, and advantages of the present disclosure clearer, the present disclosure is further described in detail below with reference to the accompanying drawings and specific embodiments. It should be understood that the specific embodiments described herein are intended only to interpret the present disclosure and do not limit the protection scope of the present disclosure.

It should be noted that when one element is referred to as “fixed to” another element, it is directly disposed on the another element or an intermediate element may exist. When one element is considered to be “connected to” another element, it is directly connected to the another element or an intermediate element may co-exist. The terms “vertical”, “horizontal”, “left”, “right” and similar expressions used herein are for illustrative purposes only, and are not meant to be unique embodiments.

Unless defined otherwise, all technical and scientific terms used herein have the same meanings as would generally understood by those skilled in the technical field to which the present disclosure belongs to. The terms used herein in the specification of the present disclosure are for the purpose of describing specific embodiments only, and are not intended to limit the present disclosure. The term “and/or” used herein includes any and all combinations of one or more associated listed items.

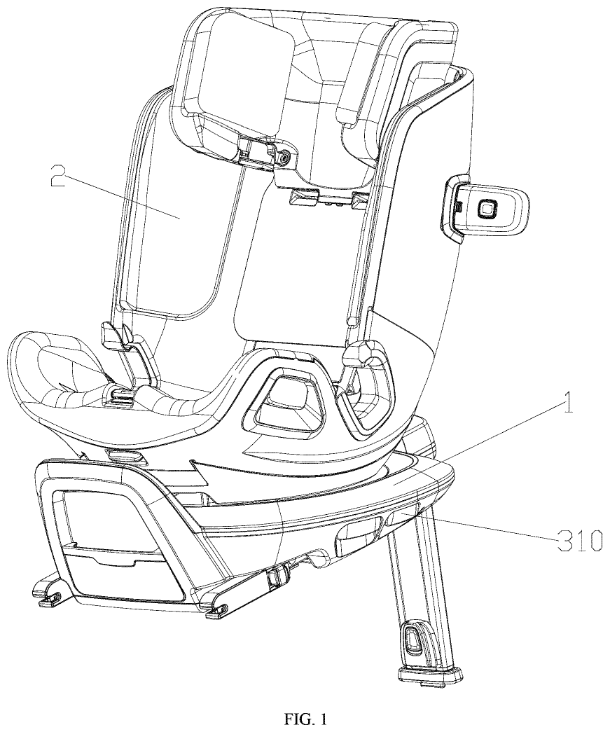

As shown in FIG. 1, an embodiment of the present disclosure provides a safety seat. The safety seat includes a safety seat base 1 and a safety seat body 2. The safety seat body 2 is an infant safety seat body suitable for infants or children below about four years old, or a child safety seat body suitable for children over about four years old.

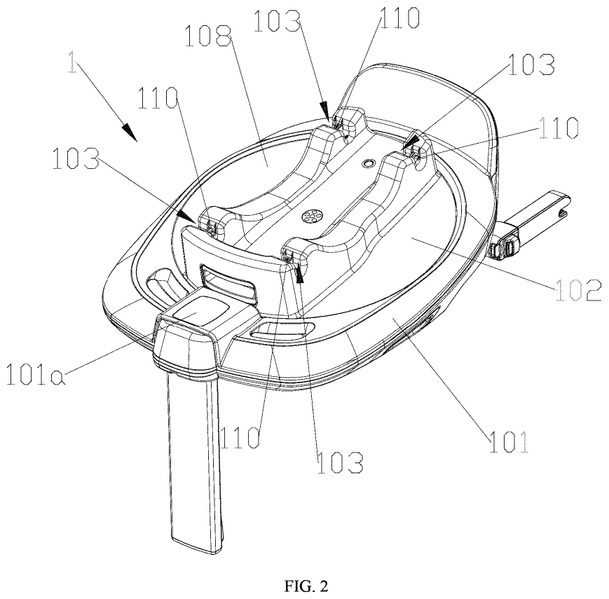

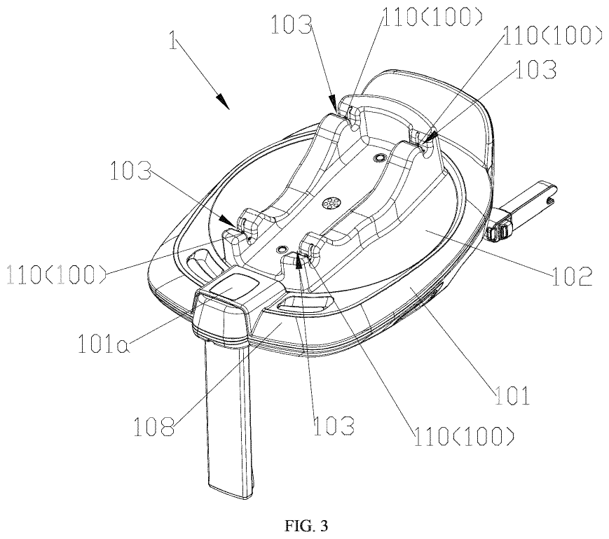

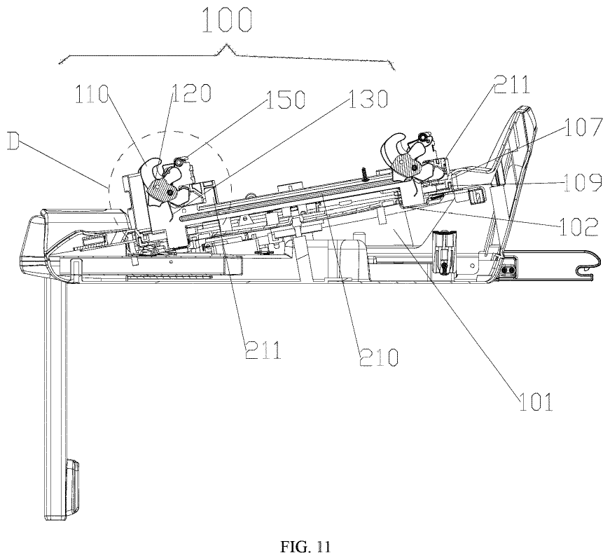

The safety seat base 1 includes a mounting base 101, a rotary plate 102, an engaging mechanism 100, a linkage mechanism 200, an operating assembly 300, and an indication mechanism 400. As shown in FIG. 2 and FIG. 3, the rotary plate 102 is rotatably arranged on the mounting base 101, and the rotary plate 102 has a first rotation position as shown in FIG. 2 and a second rotation position as shown in FIG. 3. Specifically, as shown in FIGS. 2, 5, and 11, the rotary plate 102 includes an upper cover 108 and a lower cover 109 fitting each other. A roughly middle part of the mounting base 101 includes a circular mounting receptacle 106. The mounting base 101 includes an annular mounting rib 107 arranged along a wall of the mounting receptacle 106. The mounting rib 107 is disposed between the upper cover 108 and the lower cover 109 to realize a rotatable connection between the rotary plate 102 and the mounting base 101.

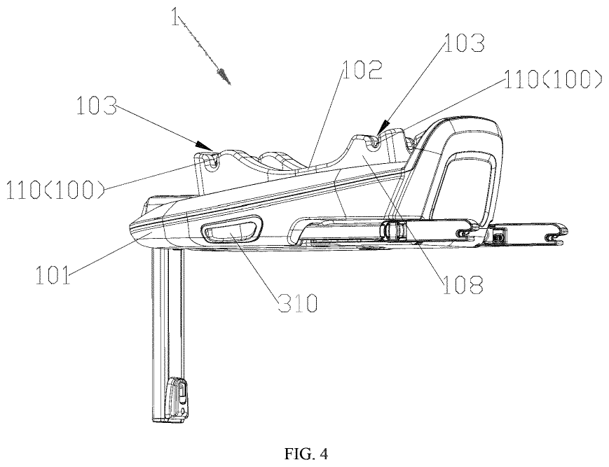

As shown in FIG. 4, the engaging mechanism 100 is configured to engage the rotary plate 102 with the safety seat body 2. Therefore, when the safety seat body 2 is engaged with the rotary plate 102, the safety seat body 2 can rotate with the rotary plate 102 relative to the mounting base 101. As shown in FIG. 2, when the safety seat body 2 rotates with the rotary plate 102 to the first rotation position, the safety seat body 2 is in a rear-facing state. That is, in this case, the front of the safety seat body 2 of the safety seat installed on the vehicle seat faces the back of a vehicle. As shown in FIG. 3, when the safety seat body 2 rotates with the rotary plate 102 to the second rotation position, the safety seat body 2 is in a forward-facing state. That is, in this case, the safety seat body 2 of the safety seat installed on the vehicle seat is facing the front of the vehicle. It is to be understood that the infant safety seat body can only be used in the rear-facing state to ensure safety of infants or children below four years old. However, the child safety seat body can be used in both the rear-facing state and the forward-facing state. In the safety seat according to the present disclosure, the child safety seat body or infant safety seat body can only be removed from the safety seat base 1 in the rear-facing state, thereby preventing misuse and a potential safety hazard.

Specifically, as shown in FIGS. 3 and 4, the upper cover 108 of the rotary plate 102 is provided with an engaging groove 103. The engaging mechanism 100 is mounted inside the rotary plate 102, that is, positioned in a space defined by the upper cover 108 and the lower cover 109, and a locking hook 110 (described in detail later) of the engaging mechanism 100 protrudes into the engaging groove 103. The bottom of the safety seat body 2 is provided with an engaging rod (not shown in the figure) for engaging with the locking hook 110. The engaging rod is engaged into the engaging groove 103 and locked to the locking hook 110 to realize engagement and locking between the rotary plate 102 and the safety seat body 2. When the engaging rod is disengaged from the locking hook 110, the safety seat body 2 can be detached from the rotary plate 102.

In the present disclosure, as shown in FIGS. 2 and 3, the rotary plate 102 is provided with four engaging grooves 103. A front end and a rear end of the rotary plate 102 are each provided with two engaging grooves 103. The two engaging grooves 103 at each end are spaced apart from each other. It should be noted that the front end and the rear end herein refer to the front and the back of the rotary plate 102, not the front and the back of the rotary plate 102 relative to a heading direction of the vehicle. Specifically, the front end of the rotary plate 102 refers to an end engaged with an end of the safety seat body 2 away from a backrest thereof, and the rear end of the rotary plate 102 refers to an end engaged with an end of the safety seat body 2 adjacent to the backrest thereof. For example, as shown in FIG. 2, when the safety seat body 2 rotates with the rotary plate 102 to the first rotation position, the safety seat body 2 is in the rear-facing state. In the rear-facing state, the rear end of the rotary plate 102 is adjacent to a display screen 101a (described in detail later), such that a higher end of the rotary plate 102 shown in FIG. 2 is adjacent to the display screen 101a, while the front end of the rotary plate 102 is away from the display screen 101a, such that a lower end of the rotary plate 102 shown in FIG. 2 is away from the display screen 101a. As shown in FIG. 3, when the rotary plate 102 rotates from the first rotation position to the second rotation position, the front end of the rotary plate 102 is adjacent to the display screen 101a, while the rear end of the rotary plate 102 is away from the display screen 101a. Correspondingly, four engaging mechanisms 100 are provided, each engaging mechanism 100 is arranged corresponding to one engaging groove 103, and the locking hook 110 of each engaging mechanism 100 protrudes into one engaging groove 103. The bottom of the safety seat body 2 is provided with four or two engaging rods. The four or two engaging rods are correspondingly engaged into the four engaging grooves 103. Understandably, the number of the engaging grooves 103 and the engaging rods are not limited thereto, which is flexibly set as required.

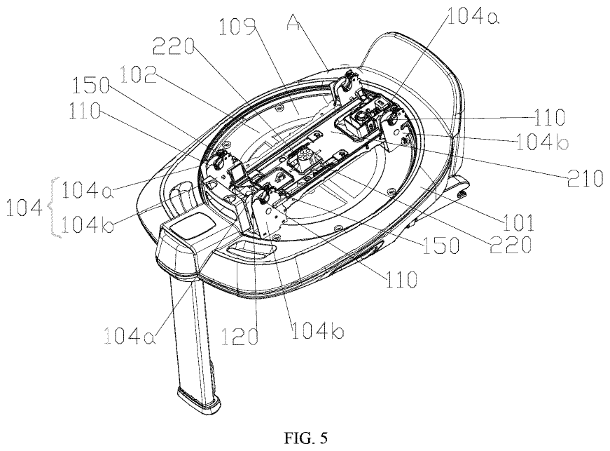

As shown in FIGS. 4 and 5, in the present disclosure, the four engaging mechanisms 100 have the same structure. Moreover, the two engaging mechanisms 100 arranged at the front end of the rotary plate 102 are symmetrically arranged, and the two engaging mechanisms 100 arranged at the rear end of the rotary plate 102 are symmetrically arranged. More specifically, the safety seat base 1 is provided with fixed assemblies 104 vertically extending. The engaging mechanisms 100 are correspondingly arranged on the fixed assemblies 104. Specifically, each of the fixed assemblies 104 includes a first fixed plate 104a and a second fixed plate 104b that are facing each other and fixed to the safety seat base 1. For example, the fixed assembly 104 is arranged on the rotary plate 102. One of the engaging mechanisms 100 is taken as an example to describe a specific structure thereof in detail below.

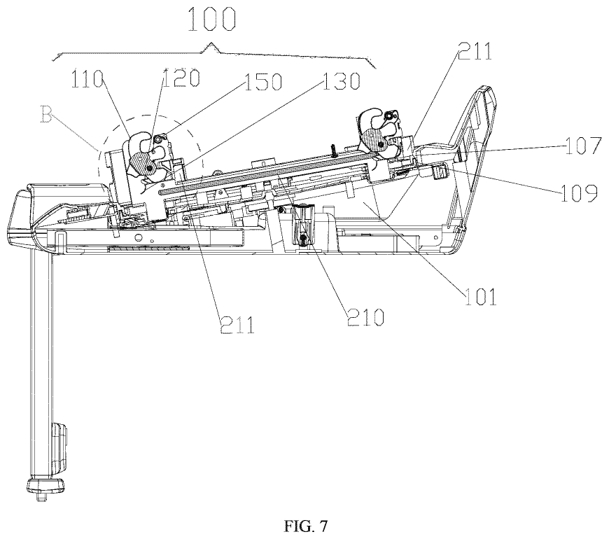

As shown in FIGS. 5 and 7, the engaging mechanism 100 includes a locking hook 110, a fixed member 120, a third reset member 130, a stopper 140, and a fourth reset member 150.

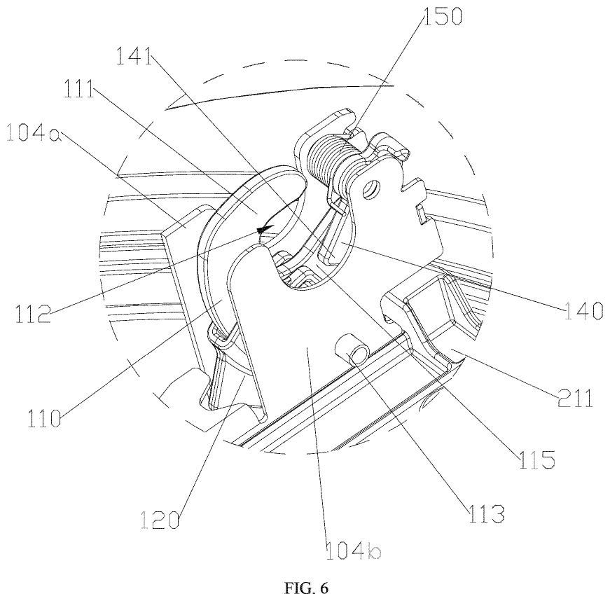

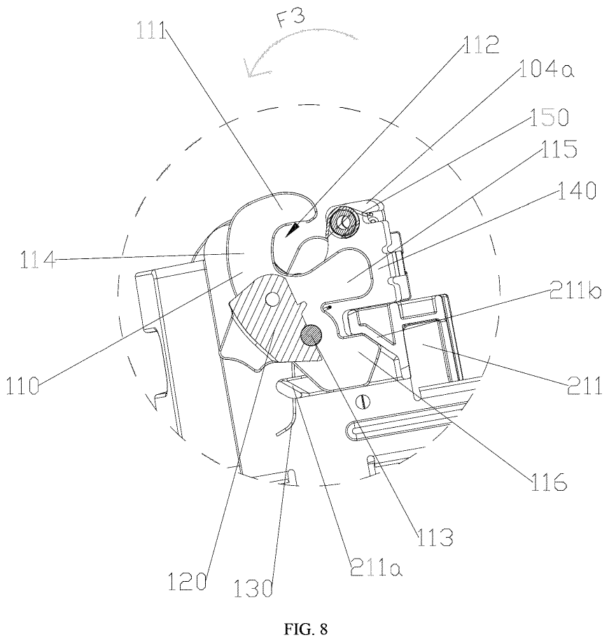

Specifically, as shown in FIGS. 6 and 8, the locking hook 110 is pivotally connected between the first fixed plate 104a and the second fixed plate 104b through a first pivot shaft 113, and has a releasing position and a closed position. The locking hook 110 has a roughly E-shaped structure, including a second connecting portion 114, and a hook portion 111, a first pushing portion 115, and a second pushing portion 116 that are sequentially connected to one side of the second connecting portion 114. A locking groove 112 is formed between the hook portion 111 and the first pushing portion 115. The hook portion 111 protrudes into the engaging groove 103. When the locking hook 110 is in the closed position, the engaging rod can be restricted in the locking groove 112. When the locking hook 110 is in the releasing position, the engaging rod can be disengaged from the locking groove 112.

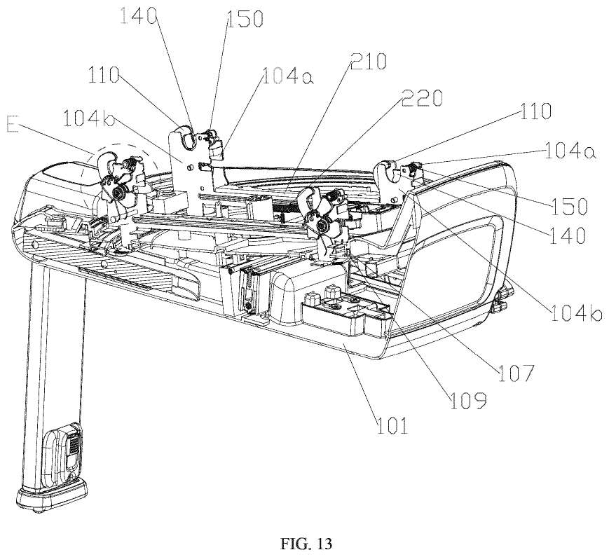

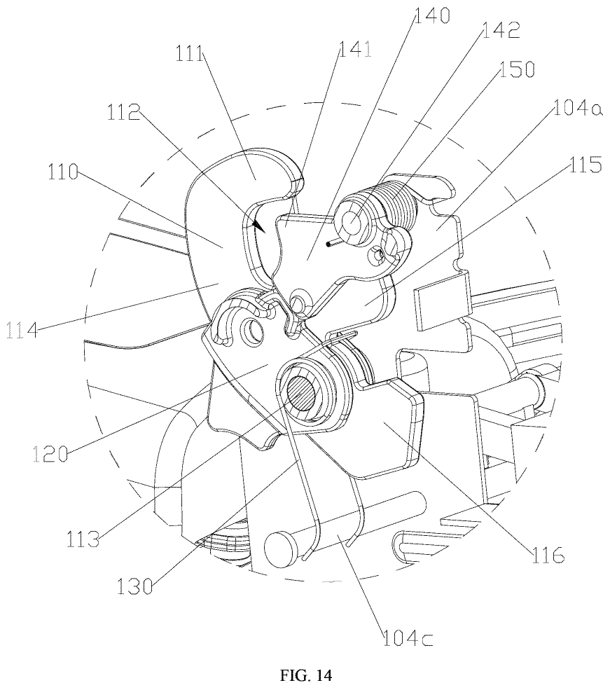

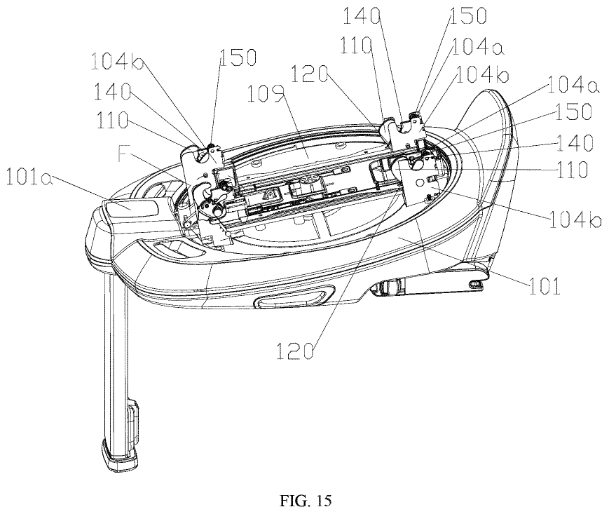

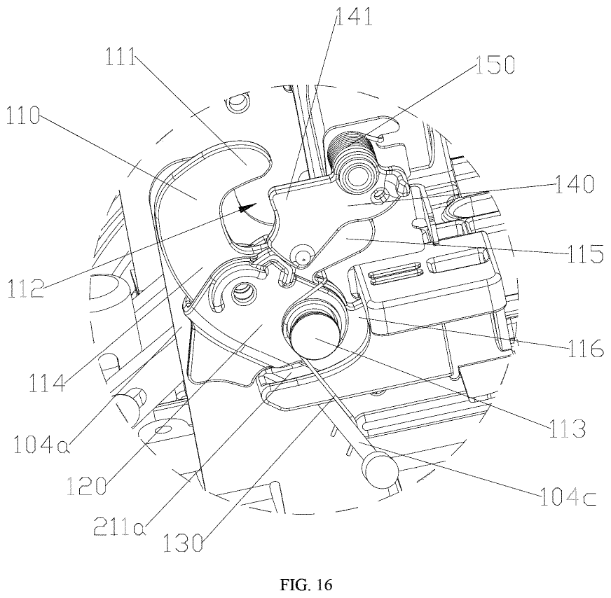

Specifically, as shown in FIGS. 6 and 8, the fixed member 120 and the locking hook 110 are fixedly connected, and are both pivotally connected between the first fixed plate 104a and the second fixed plate 104b through the first pivot shaft 113. As shown in FIGS. 13 and 14, the third reset member 130 abuts against the fixed assembly 104 and the locking hook 110, and the third reset member 130 bias the locking hook 110 to rotate toward the releasing position. Specifically, the third reset member 130 has two ends on one side. The two ends are fixed to a rivet 104c passing through the first fixed plate 104a and the second fixed plate 104b. An end portion of the third reset member 130 on the other side is fixed to a junction between the second connecting portion 114 and the second pushing portion 116. In this embodiment, the third reset member 130 is a torsion spring.

Specifically, as shown in FIG. 14, one end of the stopper 140 is pivotally connected between the first fixed plate 104a and the second fixed plate 104b, a second pivot shaft 142 of the stopper 140 is parallel to the first pivot shaft 113 of the locking hook 110, and the other end of the stopper 140 protrudes toward the fixed member 120 and is configured to abut against the fixed member 120 such that the locking hook 110 is held in the releasing position, so as to prevent rotation of the locking hook 110 toward the closed position due to manual pushing. The fourth reset member 150 is mounted on the second pivot shaft 142 of the stopper 140, with two ends respectively abutting against the first fixed plate 104a and the stopper 140. The fourth reset member 150 biases the stopper 140 in a direction of abutting against the fixed member 120. More specifically, the stopper 140 includes a protruding portion 141 protruding toward the locking hook 110. The protruding portion 141 protrudes into the engaging groove 103. In this embodiment, the fourth reset member 150 is a torsion spring.

As shown in FIG. 14, when the engaging rod moves into the engaging groove 103, the engaging rod first pushes the stopper 140, so that the stopper 140 rotates against an elastic force of the fourth reset member 150 and the stopper 140 no longer abuts the fixed member 120. Then, the engaging rod pushes the first pushing portion 115, so that the locking hook 110 rotates against an elastic force of the third reset member 130, the hook portion 111 is rotated to be above the engaging rod, and the locking hook 110 is in the closed position. In this case, a sliding member 210 (described in detail later) in the linkage mechanism 200 is engaged with the second pushing portion 116 of the locking hook 110 to keep locking of the locking hook 110 stable, as shown in FIG. 8.

Correspondingly, after the sliding member 210 moves to be disengaged from the second pushing portion 116 of the locking hook 110, the stopper 140 rotates under the elastic force of the fourth reset member 150, and at the same time, the locking hook 110 is rotated to the released position under the elastic force of the third reset member 130, so that the stopper 140 abuts against the fixed member 120 fixed to the locking hook 110 again, as shown in FIG. 14. The locking hook 110 is held in the releasing position due to the stopper 140 abutting against the fixed member 120. With a combined effect of the third reset member 130 and the fourth reset member 150, the locking hook 110 can be quickly rotated to the released position, so that detachment of the engaging rod is more labor-saving and quicker, and quick removal of the safety seat body 2 is realized.

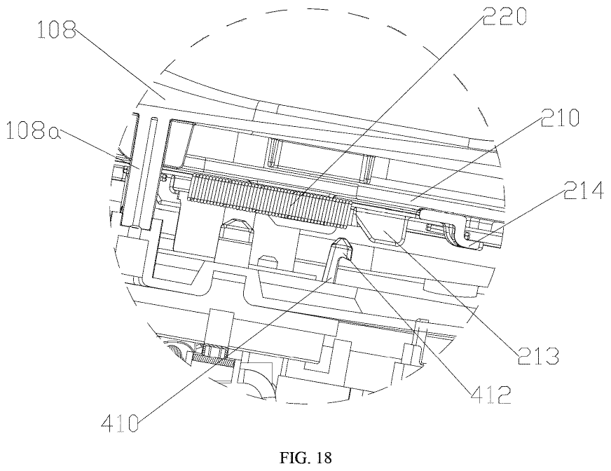

As shown in FIG. 18 to FIG. 20, the linkage mechanism 200 is arranged between the rotary plate 102 and the mounting base 101. The linkage mechanism 200 includes a sliding member 210, a second reset member 220, a driving member 230, a reinforcing pin 240, and a fifth reset member 250.

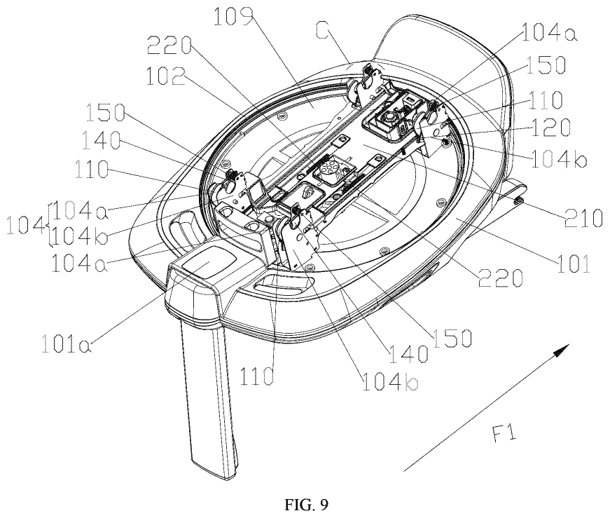

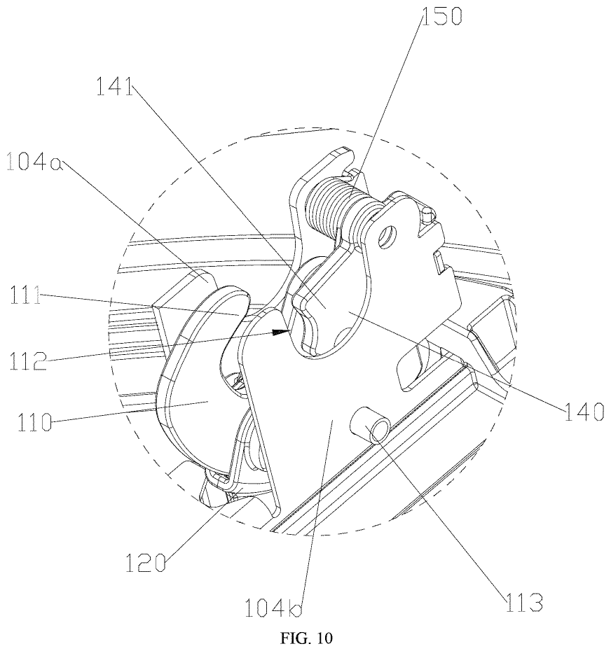

Specifically, as shown in FIGS. 9 to 12, the sliding member 210 is movably arranged in the rotary plate 102. For example, the sliding member 210 is movable along a front and rear direction of the rotary plate 102, and the sliding member 210 is configured to rotate together with the rotary plate 102. The sliding member 210 is configured to abut against four locking hooks 110 to simultaneously hold the four locking hooks 110 at the closed position, as shown in FIG. 7.

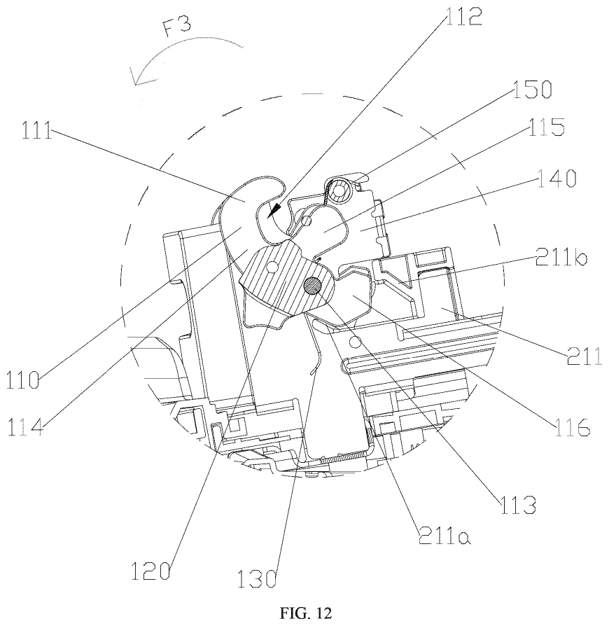

As shown in FIGS. 5 to 7, the sliding member 210 is roughly in a shape of a rectangle. Four corners of the sliding member 210 are each provided with a blocking portion 211. The four blocking portions 211 respectively abut against the four locking hooks 110 correspondingly. As shown in FIGS. 8 and 12, the blocking portions 211 are each provided with a pushing slope 211a and an engaging rib 211b. The sliding member 210 has a locked position and an unlocked position. As shown in FIGS. 5 and 8, when the sliding member 210 is in the locked position, the four blocking portions 211 thereof simultaneously hold the four locking hooks 110 in the closed position, and the engaging ribs 211b on the four blocking portions 211 are engaged with the second pushing portions 116 of the four locking hooks 110 respectively. As shown in FIGS. 9 and 12, when the rotary plate 102 is in the first rotation position (the safety seat body 2 is in the rear-facing state) and the sliding member 210 slides to the unlocked position in a direction indicated by F1 in FIG. 9, the engaging ribs 211b on the four blocking portions 211 are disengaged from the second pushing portions 116 of the four locking hooks 110 respectively, and the four locking hooks 110 pivot to the releasing position thereof. In this embodiment, during the sliding member 210 sliding to the unlocked position, the pushing slopes 211a on the four blocking portions 211 push the second connecting portions 114 of the fourth locking hooks 110 respectively to prevent the case that the third reset members 130 cannot drive the locking hooks 110 to the releasing position due to the locking hooks 110 being accidentally stuck. In some embodiment, the pushing slope 211a are alternatively omitted. As shown in FIGS. 9 and 12, the four locking hooks 110 then respectively abut against the four blocking portions 211 again to hold the sliding member 210 in the unlocked position. In this way, the four locking hooks 110 are simultaneously driven by one sliding member 210 to realize locking and unlocking synchronously, which simplifies the structure.

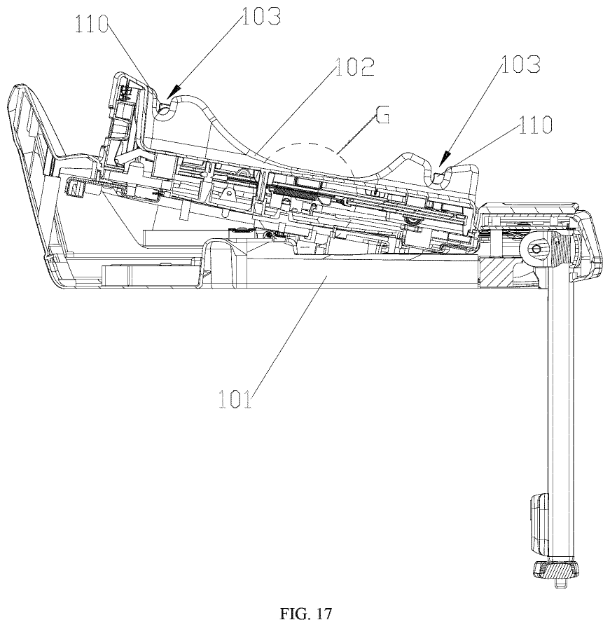

Further, the second reset member 220 has one end fixed to the sliding member 210 and the other end fixed to the upper cover 108. Specifically, as shown in FIGS. 17 and 18, the bottom of the sliding member 210 is provided with a fixed hook 214, the bottom of the upper cover 108 is provided with a fixed column 108a. One end of the second reset member 220 is arranged on the fixed hook 214, and the other end of the second reset member 220 is sleeved the fixed column 108a. The second reset member 220 bias the sliding member 210 to slide toward the locked position thereof. Through an elastic force of the second reset member 220, the sliding member 210 is always subjected to a force that bias it to abut against the locking hook 110, so that the sliding member 210 can hold the locking hook 110 in the closed position.

As shown in FIG. 5, the second reset member 220 is a tension spring, but the present disclosure is not limited thereto. In the present disclosure, two second reset members 220 are provided and are spaced apart. Each second reset member 220 has one end connected to the sliding member 210 and the other end connected to the upper cover 108. The second reset member 220 always exerts a force that pulls the sliding member 210 to a rear end of the upper cover 108 of the rotary plate 102, that is, always bias the sliding member 210 to move to the rear end of the upper cover 108 of the rotary plate 102.

Referring to FIGS. 5 to 8, when the engaging rod pushes the stopper 140, the stopper 140 rotates and no longer abuts the fixed member 120, and then the engaging rod pushes the first pushing portion 115, so that the locking hook 110 rotates to be above the engaging rod, and the locking hook 110 is in the closed position. In this process, both the third reset member 130 and the fourth reset member 150 are deformed. The locking hook 110, when being in the closed position, is held at the closed position due to the engagement of the sliding member 210 with the second pushing portion 116 of the locking hook 110. As shown in FIGS. 9 to 12, when the sliding member 210 slides to the unlocked position in the direction indicated by F1, the sliding member 210 applies no force to the locking hook 110, the fourth reset member 150 returns to its original form and drives the stopper 140 to rotate, and the third reset member 130 returns to its original form and drives the locking hook 110 to automatically pivot to the releasing position in a direction indicated by F3 in FIG. 8, so that the locking hook 110 releases the locking for the engaging rod, allowing the engaging rod to move out of the engaging groove 103, thereby allowing the safety seat body 2 to be detached from the rotary plate 102. As shown in FIGS. 13 and 14, for the locking hook 110 in the releasing position, the stopper 140 abuts against the fixed member 120 fixed to the locking hook 110 to hold the locking hook 110 in the releasing position, and the sliding member 210 moves in a direction opposite to the direction indicated by F1 under the force of the second reset member 220 until the four blocking portions 211 respectively abut against the second pushing portions 116 of the four locking hooks 110 and are held in the unlocked position.

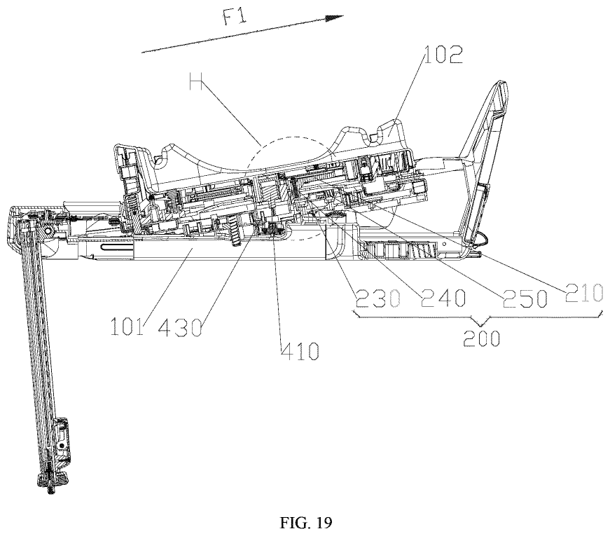

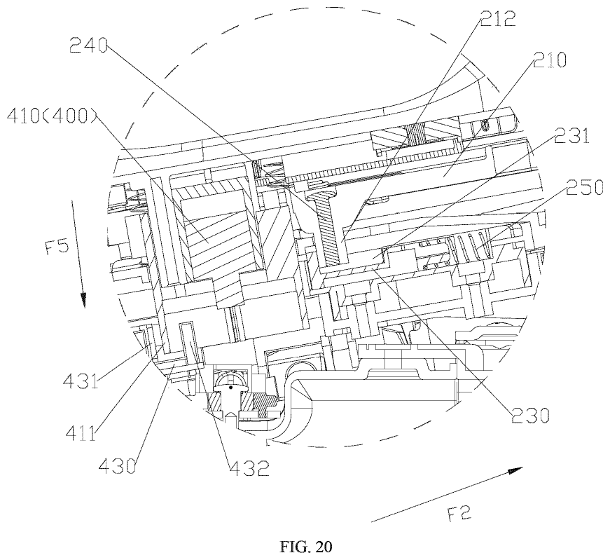

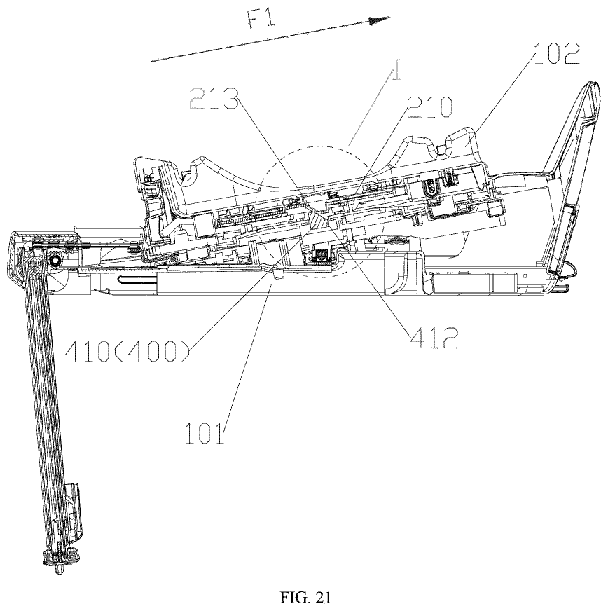

Further, as shown in FIGS. 19 and 20, the sliding member 210 includes a transmission rib 212 at a side facing the mounting base 101. The transmission rib 212 passes through the lower cover 109 and protrudes into the mounting base 101. In this embodiment, the transmission rib 212 is positioned at a position in the rotary plate 102 near a front end of the lower cover 109. In this embodiment, the transmission rib 212 is part of the sliding member 210, that is, the sliding member 210 including the transmission rib 212 is an integrally formed structure. In this way, on the one hand, manufacturing and assembly steps can be simplified, and on the other hand, strength of the transmission rib 212 can also be ensured. In other embodiments, the transmission rib 212 is an element independent of the sliding member 210, and is fixed to the sliding member 210 by means of riveting, welding or the like. In order to further improve the strength of the transmission rib 212, a reinforcing pin 240 is further embedded in and fixed to the transmission rib 212, so as to prolong the service life of the transmission rib 212. A push convex 213 extending toward the mounting base 101 is provided in a roughly middle part of the sliding member 210.

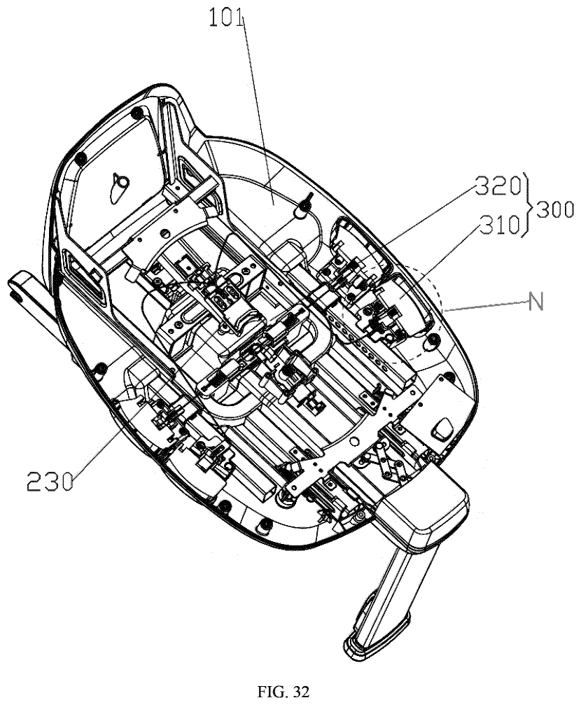

Specifically, as shown in FIGS. 19 and 20, the driving member 230 is movably arranged at a position in the mounting base 101 adjacent to the rear end thereof. For example, the driving member 230 is movable along a front and rear direction of the mounting base 101. The driving member 230 is roughly in a shape of a rectangle. A side of the driving member 230 adjacent to the rear end of the mounting base 101 is connected to the operating assembly 300 (see FIG. 32), and the other side of the driving member 230 is provided with a second pushing groove 231. It should be noted that, herein, since the mounting base 101 is fixed to the vehicle, the front end and the rear end of the mounting base 101 are consistent with the front and the back of the heading direction of the vehicle. When the rotary plate 102 rotates to the first rotation position, that is, when the rotary plate 102 is arranged in a rear-facing manner, the transmission rib 212 is positioned in the second pushing groove 231, and the transmission rib 212 is configured to abut against a groove wall of the second pushing groove 231.

In this way, when the rotary plate 102 rotates to the first rotation position, that is, when the rotary plate 102 is arranged in a rear-facing manner, as shown in FIGS. 2 and 20, if the driving member 230 is driven to move in a direction indicated by F2 by the operating assembly 300, the groove wall of the second pushing groove 231 pushes the transmission rib 212 to also move in the direction F2, such that the sliding member 210 also moves in the direction F2. When the sliding member 210 slides in the direction F2 to the unlocked position, the sliding member 210 applies no force to the locking hook 110, the fourth reset member 150 returns to its original form and drives the stopper 140 to rotate, and the third reset member 130 returns to its original form and drives the locking hook 110 to automatically pivot to the releasing position in the direction indicated by F3 in FIG. 12, so that the locking hook 110 releases the locking for the engaging rod, allowing the engaging rod to move out of the engaging groove 103, thereby allowing the safety seat body 2 to be detached from the rotary plate 102.

When the rotary plate 102 rotates to the second rotation position, that is, when the rotary plate 102 is arranged in a forward-facing manner, as shown in FIG. 3, since the sliding member 210 and the transmission rib 212 thereof rotate with the rotary plate 102 to a position away from the rear end of the mounting base 101, that is, a position away from the driving member 230, even if the driving member 230 is driven by the operating assembly 300 to move, the driving member 230 cannot push the transmission rib 212 to move, that is, cannot drive the sliding member 210 to move to cause the engaging mechanism 100 to be unlocked. In this way, the safety seat body 2 can only be detached when rotating to the first rotation position (i.e., being in the rear-facing state), which can prevent misuse of the infant safety seat body being used in the forward-facing state caused by that the user engages the infant safety seat body with the safety seat base 1 after the child safety seat body in the second rotation position is removed, thereby improving a safety factor.

As shown in FIGS. 19 and 20, the fifth reset member 250 has one end abutting against a side of the driving member 230 adjacent to the rear end of the mounting base 101 and the other end abutting against the mounting base 101. The fifth reset member 250 bias the driving member 230 to move in a direction opposite to a direction in which the driving member 230 is pulled by the operating assembly 300, that is, a direction opposite to the direction F2 in the figure. In this embodiment, the fifth reset member 250 is a spring. In this way, after the safety seat body 2 is removed from the safety seat base 1 and the operating member 310 described below is released, and the driving member 230 resets driven by the fifth reset member 250, so that the groove wall of the second pushing groove 231 of the driving member 230 no longer pushes the transmission rib 212 of the sliding member 210, such that the driving member 230 applies no force to the sliding member 210, and the sliding member 210 moves in the direction opposite to the direction indicated by F1 under the force of the second reset member 220 until the four blocking portions 211 respectively abut against the second pushing portions 116 of the four locking hooks 110 and are held in the unlocked position. In this embodiment, the direction F1 is substantially the same as the direction F2.

In another embodiment of the present disclosure, a linkage mechanism 200′ is provided. The linkage mechanism 200′ is arranged between the rotary plate 102 and the mounting base 101. The linkage mechanism 200′ includes a sliding member 210′, a second reset member 220′, a driving member 230′, a linkage member 240′, and a fifth reset member 250′.

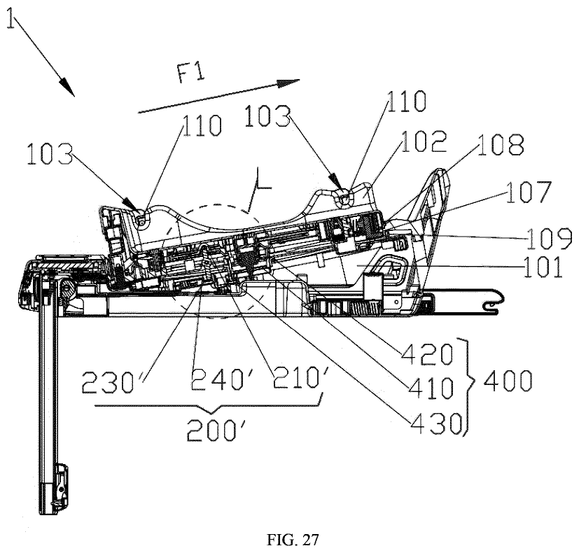

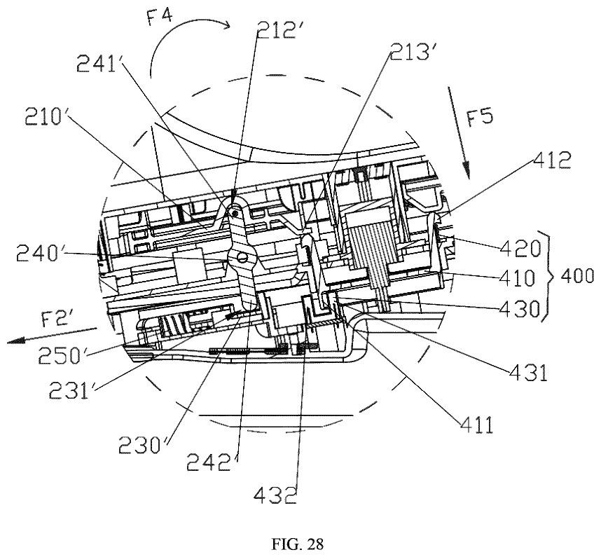

Specifically, as shown in FIGS. 27 to 28, the sliding member 210′ is movably arranged in the rotary plate 102, and the sliding member 210′ is configured to abut against the four locking hooks 110 to simultaneously hold the four locking hooks 110 in the closed position.

The sliding member 210′ is roughly in a shape of a rectangle, four corners of the sliding member 210′ are each provided with a blocking portion 211, and the four blocking portions 211 respectively abut against the four locking hooks 110 correspondingly. The blocking portions 211 are each provided with a pushing slope 211a and an engaging rib 211b. The sliding member 210′ has a locked position and an unlocked position. When the sliding member 210′ is in the locked position, the four blocking portions 211 thereof simultaneously hold the four locking hooks 110 in the closed position, and the engaging ribs 211b on the four blocking portions 211 are engaged with the second pushing portions 116 of the four locking hooks 110 respectively. When the sliding member 210′ slides to the unlocked position in the direction indicated by F1 in the figure, the four locking hooks 110 pivot to the releasing position thereof. In this embodiment, during the sliding member 210′ sliding to the unlocked position, the pushing slopes 211a on the four blocking portions 211 push the second connecting portions 114 of the four locking hooks 110 respectively to prevent the case that the third reset member 130 cannot drive the locking hooks 110 to the releasing position due to the locking hooks 110 being accidentally stuck. In some embodiment, the pushing slope 211a are alternatively omitted. The four locking hooks 110 then respectively abut against the four blocking portions 211 again to hold the sliding member 210′ in the unlocked position, and the four locking hooks 110 are simultaneously driven by the sliding member 210′ to realize locking and unlocking synchronously, which simplifies the structure.

Further, as shown in FIGS. 27 and 28, a side of the sliding member 210′ facing the mounting base 101 is provided with a first pushing groove 212′. In this embodiment, the first pushing groove 212′ is arranged at a position corresponding to a position of the lower cover 109 adjacent to a rear end of the lower cover 109. A push convex 213′ extending toward the mounting base 101 is provided in a roughly middle part of the sliding member 210′.

The second reset member 220′ has one end fixed to the sliding member 210′ and the other end fixed to the upper cover 108. In addition, a specific structure and a function of the second reset member 220′ are the same as those of the second reset member 220 in the above embodiment, and details thereof are not repeatedly described herein again.

As shown in FIGS. 27 to 28, the driving member 230′ is movably arranged at a position in the mounting base 101 adjacent to the front end thereof. The driving member 230′ is roughly in a shape of a rectangle. A side of the driving member 230′ adjacent to the front end of the mounting base 101 is connected to the operating assembly 300, and the other side of the driving member 230′ is provided with a second pushing groove 231′.

The linkage member 240′ is pivotally connected to the rotary plate 102. The driving member 230′ is configured to be operable to drive the linkage member 240′ to rotate when the rotary plate 102 rotates to the first rotation position, and the rotation of the linkage member 240′ drives the sliding member 210′ to slide, thereby driving the engaging mechanism 100 to be unlocked. The linkage member 240′, as a specific example, includes a first end and a second end. When the rotary plate 102 rotates to the first rotation position, the first end abuts against the sliding member 210′, and the second end abuts against the driving member 230′.

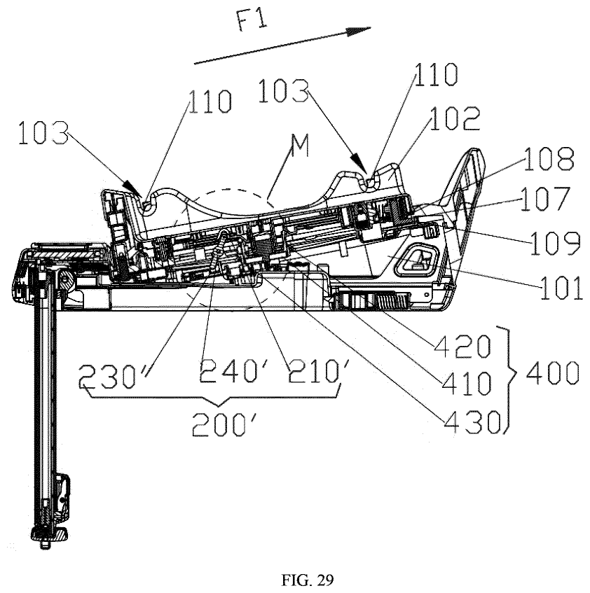

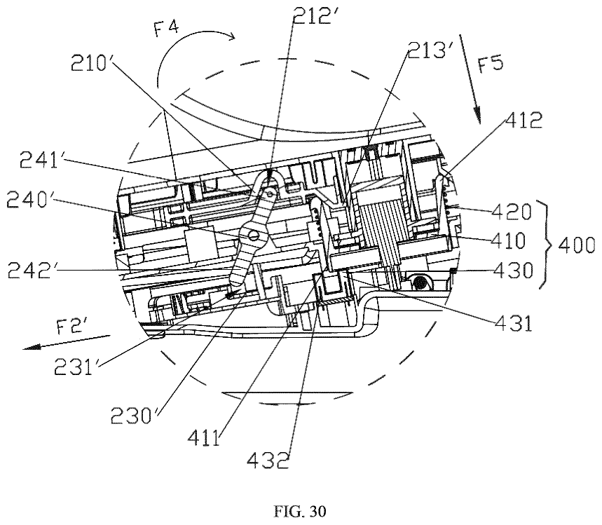

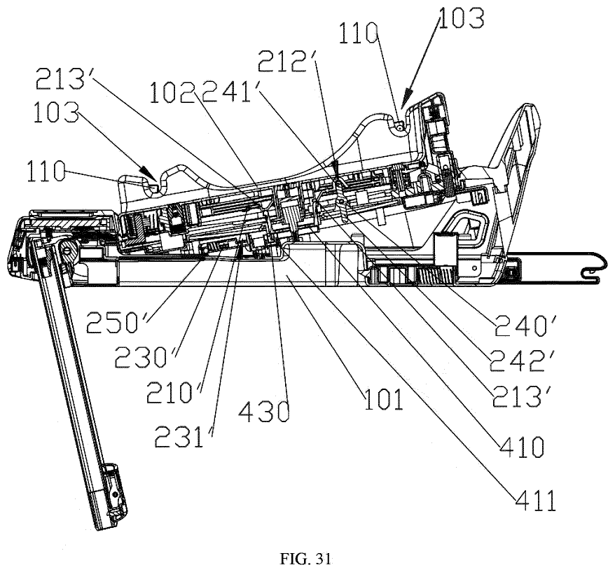

Specifically, as shown in FIGS. 27 and 28, the linkage member 240′ is pivotally connected to the lower cover 109, and positioned at a position adjacent to the rear end of the lower cover 109. The linkage member 240′ is roughly in a shape of a strip. Two ends of the linkage member 240′ are a first end 241′ and a second end 242′ respectively. The first end 241′ is positioned in the first pushing groove 212′. When the rotary plate 102 rotates to the first rotation position, that is, when the rotary plate 102 is arranged in a rear-facing manner, the second end 242′ is positioned in the second pushing groove 231′ of the driving member 230′, and the first end 241′ is configured to abut against a groove wall of the first pushing groove 212′, and the second end 242′ is configured to abut against a groove wall of the second pushing groove 231′. In this way, when the rotary plate 102 rotates to the first rotation position, that is, when the rotary plate 102 is arranged in a rear-facing manner, as shown in FIGS. 29 and 30, if the driving member 230′ is driven to move in a direction indicated by F2′ (opposite to the direction F2 shown in FIG. 20) by the operating assembly 300, the groove wall of the second pushing groove 231′ pushes the linkage member 240′ to move in a direction F4 shown in FIG. 28, and the first end 241′ of the linkage member 240′ pushes the sliding member 210′ to move toward the unlocked position in the direction indicated by F1. The sliding member 210′ applies no force to the locking hook 110, so that the fourth reset member 150 returns to its original form and drives the stopper 140 to rotate, and the third reset member 130 returns to its original form and drives the locking hook 110 to automatically pivot to the releasing position in the direction indicated by F3 in FIG. 12, so that the locking hook 110 releases the locking for the engaging rod, allowing the engaging rod to move out of the engaging groove 103, thereby allowing the safety seat body 2 to be detached from the rotary plate 102. When the rotary plate 102 rotates to the second rotation position, that is, when the rotary plate 102 is arranged in a forward-facing manner, as shown in FIG. 31, since the linkage member 240′ rotates with the rotary plate 102 to a position away from the front end of the mounting base 101, that is, a position away from the driving member 230′, even if the driving member 230′ is driven by the operating assembly 300 to move in the direction indicated by F2′, the driving member 230′ cannot push the linkage member 240′ to rotate, and thus cannot drive the sliding member 210′ to move to cause the engaging mechanism 100 to be unlocked. In other words, when the rotary plate 102 rotates to the second rotation position, the second end 242′ and the driving member 230′ are spaced apart, and incapable of contacting each other. In this way, the safety seat body 2 can only be detached from the safety seat base 1 when rotating to the first rotation position (i.e., being in the rear-facing state), which can prevent misuse of the infant safety seat body being used in the forward-facing state caused by that when the user engages the infant safety seat body with the safety seat base 1 after the child safety seat body in the second rotation position is removed, thereby improving the safety factor.

As shown in FIGS. 27 and 28, the fifth reset member 250′ has one end abutting against a side of the driving member 230′ adjacent to the front end of the mounting base 101 and the other end abutting against the mounting base 101. The fifth reset member 250′ bias the driving member 230′ to move in a direction opposite to a direction in which the driving member 230′ is pulled by the operating assembly 300, that is, a direction opposite to the direction F2′ in FIG. 28.

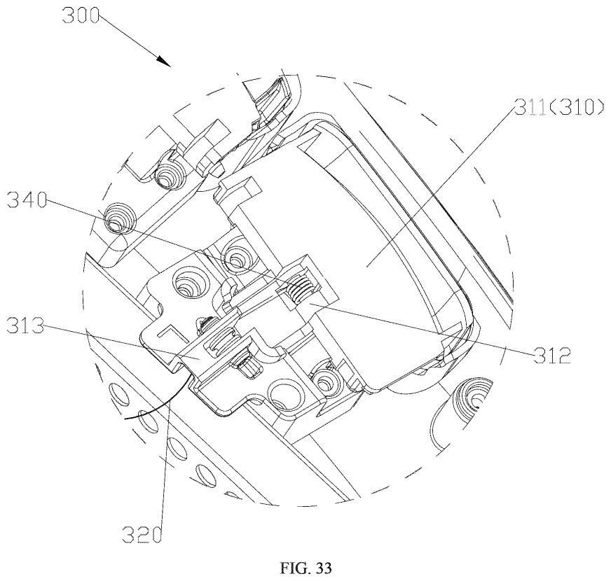

As shown in FIGS. 32 to 34, the operating assembly 300 includes an operating member 310, a pulling member 320, a pivot shaft, and a sixth reset member 340 (see FIG. 33).

As shown in FIG. 32, two operating members 310 are provided and are respectively movably arranged on two sides of the mounting base 101 and exposed to a side surface of the mounting base 101, to facilitate user's operations. Certainly, in other embodiments, the operating member 310 may also be arranged at the front end of the mounting base 101. The operating member 310 positioned on the side of the mounting base 101 is convenient to operate compared with the operating member 310 being positioned at the front end of the mounting base 101. The front end of the mounting base 101 is often difficult to reach due to blocking of the safety seat body 2 and vehicle seats in a front row, while the side of the mounting base 101 directly faces an operator, which it is thus easier to operate. For example, the operating member 310 is a handle.

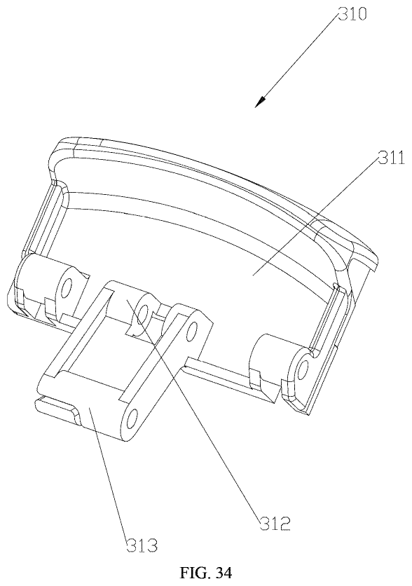

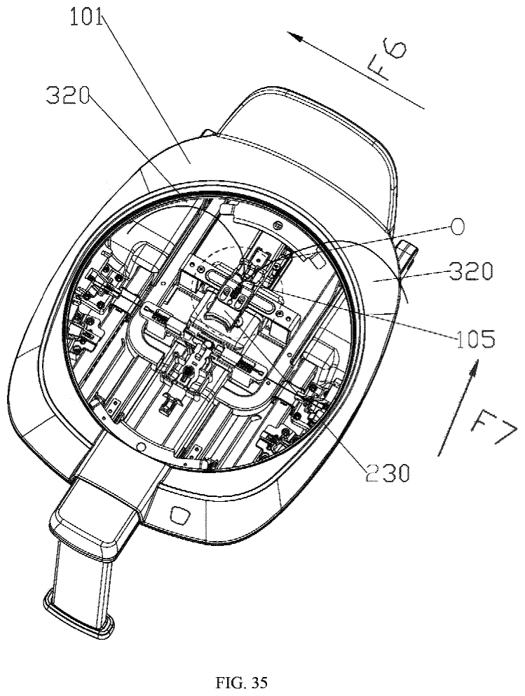

As shown in FIGS. 33 and 34, one operating member 310 is taken as an example to specifically introduce a structure of the operating member 310 below. The operating member 310 includes an operating portion 311, a pivot portion 312, and a first connecting portion 313 that are sequentially arranged. Two sides of the mounting base 101 are each provided with a pivot shaft (not shown in the figure). Each operating member 310 is pivotally connected to the pivot shaft on one of the sides through the pivot portion 312, and the operating portion 311 and the first connecting portion 313 are positioned on two sides of the pivot shaft respectively. The operating portion 311 is operable, and the first connecting portion 313 is configured to be connected to the pulling member 320. In this way, the operating portion 311, when being operated to rotate around the pivot shaft, may simultaneously drive the first connecting portion 313 to rotate and pull the pulling member 320 to move.

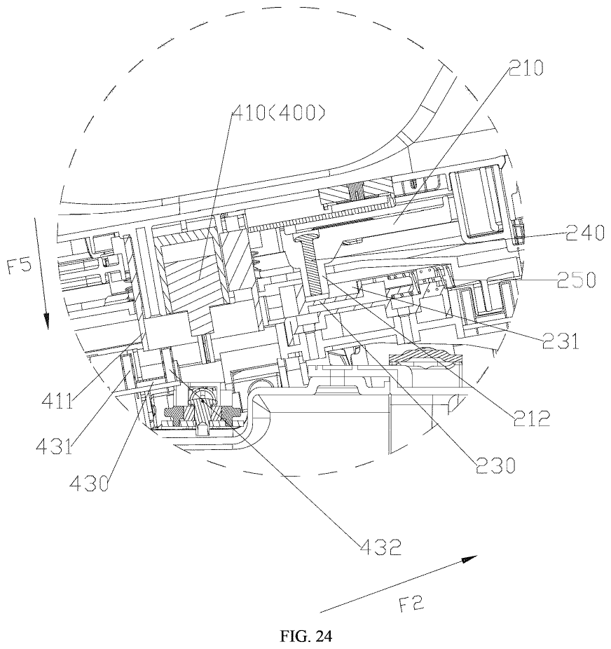

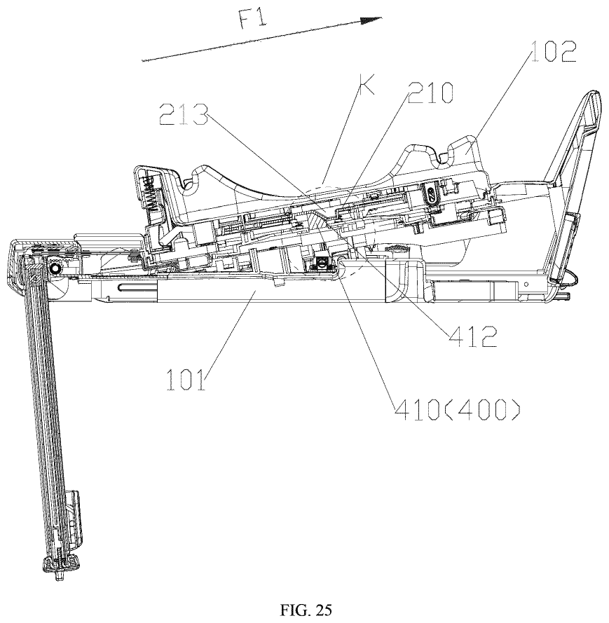

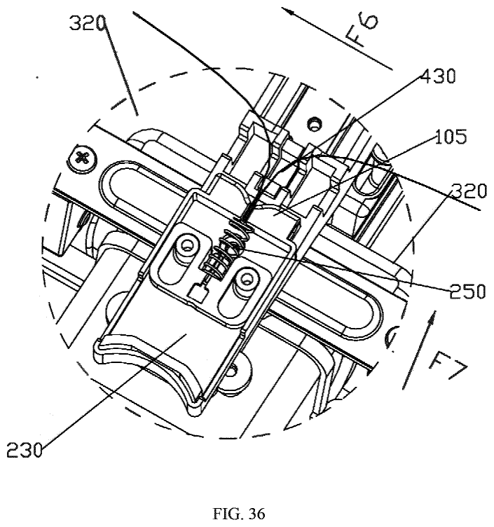

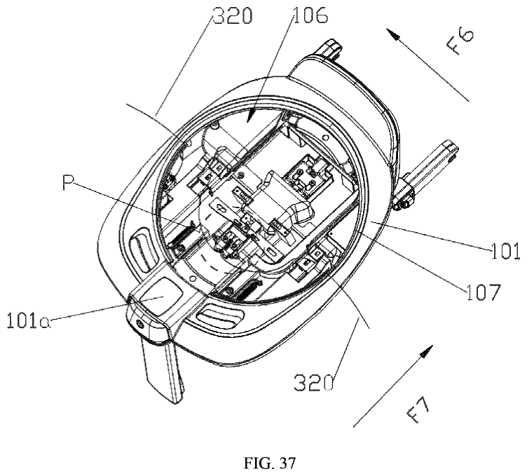

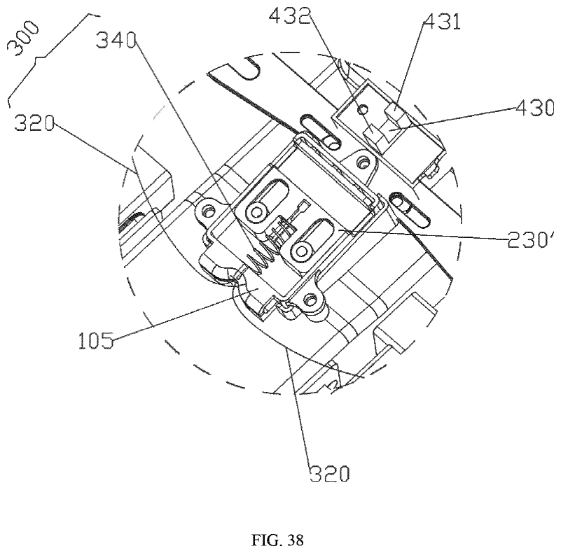

As shown in FIG. 32, two pulling members 320 are correspondingly provided, and each pulling member 320 is connected between the first connecting portion 313 of the operating member 310 on one side and the driving member 230. As shown in FIGS. 37 and 38, when the safety seat base 1 includes the linkage mechanism 200′, each pulling member 320 is connected between the first connecting portion 313 and the driving member 230′. When the operating portion 311 is operated, the operating member 310 is rotated around the pivot shaft, thereby driving, through the first connecting portion 313, the pulling member 320 to move, and the pulling member 320 then pulls the driving member 230 to move in the direction F2 in FIG. 24. In an alternative example, when the operating portion 311 is operated, the operating member 310 is rotated around the pivot shaft, thereby driving, through the first connecting portion 313, the pulling member 320 to move, and the pulling member 320 then pulls the driving member 230′ to move in the direction F2′ in FIG. 30. In this embodiment, the pulling member 320 is configured to pull the driving member 230 by upward operating and moving the operating portion 311, as shown in FIG. 36, or the pulling member 320 can pull the driving member 230′ by upward operating and moving the operating portion 311, as shown in FIG. 38. Certainly, in other embodiments, the operating portion 311 may also be operated in other manners. The pulling member 320 is a steel wire rope, but which is not limited thereto, which may also be other similar components with toughness and strength. Specifically, as shown in FIG. 36, the mounting base 101 is provided with a guiding member 105. The guiding member 105 is provided with an arc-shaped guiding portion. One end of the pulling member 320 is connected to the operating portion 311 of the operating member 310 on either side, and the other end of the pulling member 320 enters the mounting base 101 along a direction indicated by F6 (i.e., a lateral width direction of the mounting base 101), and under the guiding of the guiding member 105, bypasses the guiding portion and is connected to the driving member 230 along a direction indicated by F7 (i.e., a length direction of the mounting base 101).

Further, two sixth reset members 340 are also provided. Each sixth reset member 340 is arranged between one of the operating members 310 and the mounting base 101. The sixth reset member 340 always causes the operating member 310 to rotate to a position at which the operating member 310 is not operated. Specifically, the sixth reset member 340 is a torsion spring. A spring coil of the torsion spring is sleeved on the pivot shaft, and two ends of the torsion spring abut against the operation portion 311 and the mounting base 101 respectively. In this way, when the operating portion 311 is upward (or downward) moved, the torsion spring is deformed. When the external force applied to the operating portion 311 is removed, the operating portion 310 can be reset under an elastic force of the sixth reset member 340.

Specifically, as shown in FIGS. 20, 22, and 40, the indication mechanism 400 includes a detector 410, a first reset member 420, a sensor 430, and a controller (not shown in the figure). It should be understood that, whether the safety seat base 1 includes the linkage mechanism 200 or the linkage mechanism 200′, the indicating mechanism 400 has the same structure and can achieve the same function. That is, upon comparison between an embodiment in which the safety seat base 1 includes the linkage mechanism 200 and an embodiment in which the safety seat base 1 includes the linkage mechanism 200′, an only difference lies in different positions of the indication mechanism 400 relative to the linkage mechanism 200 and the linkage mechanism 200′. Therefore, the indication mechanism 400 will be described below by way of an example in which the safety seat base 1 includes the linkage mechanism 200.

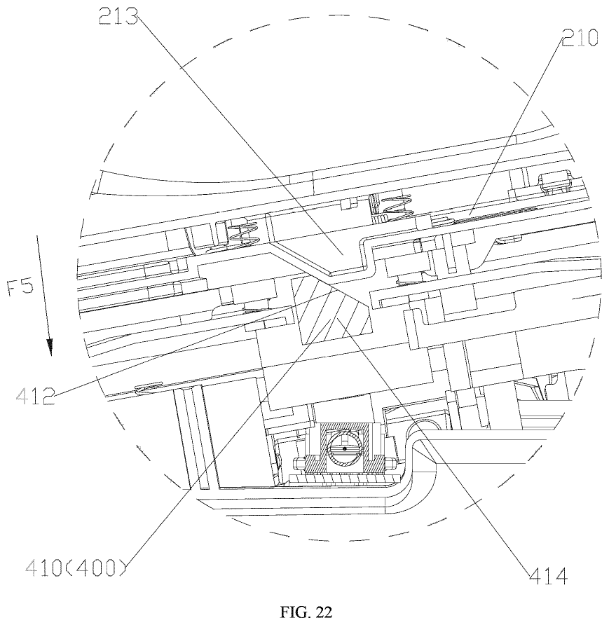

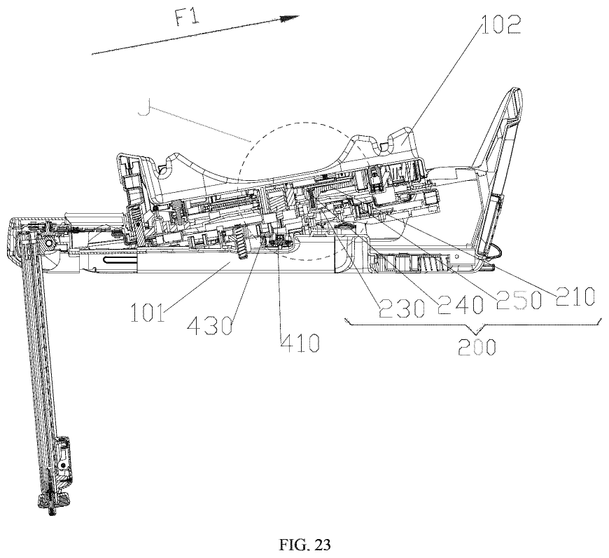

As shown in FIG. 20, the detector 410 is specifically a push button movably arranged between the rotary plate 102 and the mounting base 101. For example, the detector 410 is specifically arranged between the rotary plate 102 and the mounting base 101 in a manner of moving up and down. One end of the detector 410 positioned in the mounting base 101 (i.e., a bottom end of the detector 410) is provided with a detection rib 411. In this embodiment, the sensor 430 is a photoelectric sensor 430. The photoelectric sensor 430 is arranged in the mounting base 101 and is positioned below the detector 410. The photoelectric sensor 430 includes a transmitting end 431 and a receiving end 432 arranged oppositely. The transmitting end 431 is configured to send an optical signal to the receiving end 432. As shown in FIGS. 22, 26, and 40, a roughly middle part of the detector 410 is provided with a push block 414. The push block 414 can at least partially extend into the rotary plate 102 to abut against the push convex 213. The push block 414 includes a pushing slope 412. The sliding member 210, when sliding, pushes, through the push convex 213, the pushing slope 412 of the push block 414 to drive the detector 410 to move along a direction intersecting with a sliding direction of the sliding member 210. In this case, the detection rib 411 can protrude into the mounting base 101 and be detected by the sensor 430. In this embodiment, an inclination direction of the pushing slope 412 is from the rear end of the mounting base 101 to the front end of the mounting base 101.

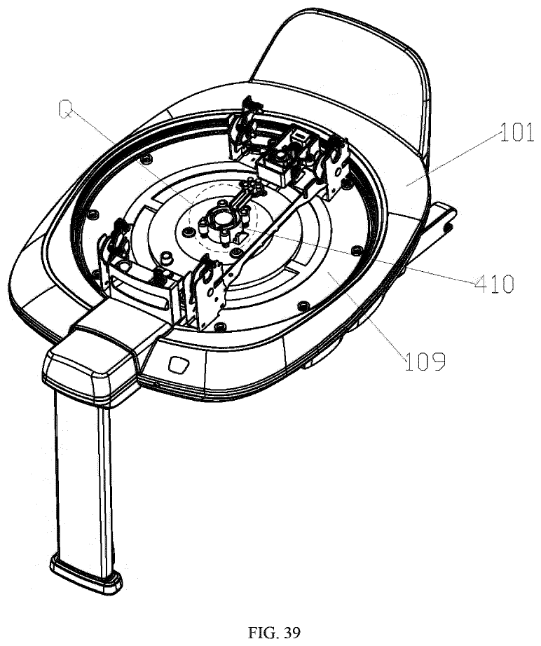

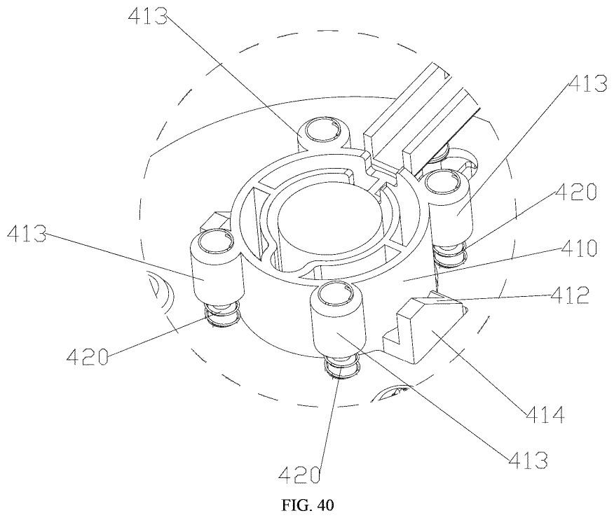

As shown in FIGS. 39 and 40, an end of the detector 410 positioned in the rotary plate 102 (i.e., an upper end of the detector 410) is provided with a lug 413 protruding along a radial direction thereof. Two ends of the first reset member 420 abut against the lower cover 109 and the lug 413 respectively. The first reset member 420 always causes the detector 410 to move in a direction opposite to a direction in which the detector 410 is pushed by the sliding member 210. In other words, the first reset member 420 is arranged between the detector 410 and the rotary plate 102, and the first reset member 420 always causes the detector 410 to rotate in a direction away from the mounting base 101. In this embodiment, the first reset member 420 is a spring. Optionally, a plurality of first reset members 420 is provided. For example, in this embodiment, four lugs 413 are provided and evenly spaced apart in a circumferential direction, and four first reset members 420 are also correspondingly provided. In other embodiments, more than four or less than four first reset members 420 may also be provided.

When the safety seat body 2 is mounted on the safety seat base 1, that is, the engaging rod is engaged with the locking hook 110, the sliding member 210 moves to the locked position in the direction opposite to the direction indicated by F1 under the elastic force of the second reset member 220, so that the locking hook 110 is held in the closed position. At the same time, as shown in FIGS. 20 and 22, the sliding member 210 pushes the detector 410 to move in a direction F5 through the push convex 213. That is, the detection rib 411 moves in the direction F5 and is interposed between the transmitting end 431 and the receiving end 432. The receiving end 432 cannot receive the optical signal from the transmitting end 431 due to the blocking of the detection rib 411, and sends information indicating that the rotary plate 102 and the safety seat body 2 are engaged in place, to the controller.

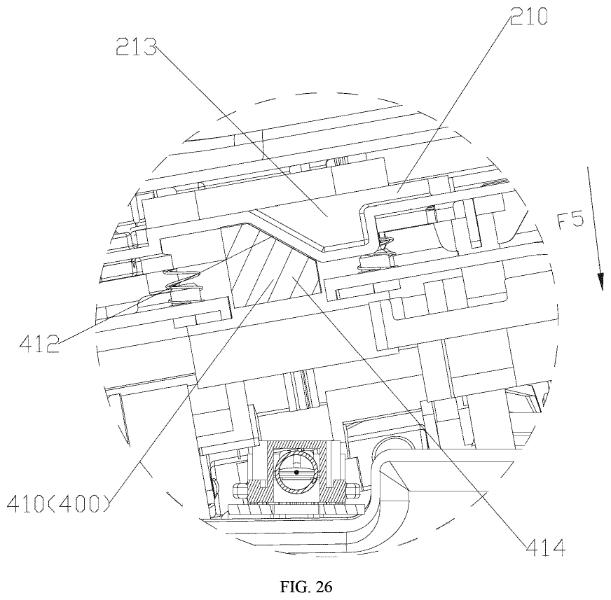

When the operating assembly 300 is operated and drives, through the driving member 230, the sliding member 210 to slide along the direction indicated by F1 to the unlocked position, the locking hook 110 rotates to the releasing position, so that the locking hook 110 releases the locking for the engaging rod, allowing the safety seat body 2 to move away from the rotary plate 102. As shown in FIGS. 24 and 26, in this case, the push convex 213 no longer pushes the detector 410, the detector 410 moves in a direction away from the sensor 430 driven by the first reset member 420, so that the detection rib 411 withdraws from between the transmitting end 431 and the receiving end 432, and the receiving end 432 receives the optical signal from the transmitting end 431, i.e., sends information indicating that the rotary plate 102 and the safety seat body 2 are not engaged, to the controller, or stops sending the information indicating that the rotary plate 102 and the safety seat body 2 are engaged in place, to the controller. The stopper 140 abuts against the fixed member 120 fixed to the locking hook 110 to hold the locking hook 110 in the releasing position, so that the locking hook 110 cannot be closed. The sliding member 210 may move in the direction opposite to the direction indicated by F1 under the elastic force of the second reset member 220 until the four blocking portions 211 respectively abut against the second pushing portions 116 of the four locking hooks 110 and are held in the unlocked position. In this case, since the sliding member 210 in the unlocked position is closer to the rear end of the mounting base 101 (i.e., the right side in FIG. 26) than the sliding member 210 in the locked position, and the push convex 213 still does not abut against the lug 413 of the detector 410, the detection rib 411 is still not interposed between the transmitting end 431 and the receiving end 432.

In this embodiment, the controller sends the information indicating that the rotary plate 102 and the safety seat body 2 are engaged in place or the information indicating that the rotary plate 102 and the safety seat body 2 are not engaged, sent by the sensor 430, to a mobile terminal such as a mobile phone, to remind the user of an engagement state of the safety seat body 2. Alternatively, in other embodiments, as shown in FIGS. 2 and 3, a display screen 101a is arranged on the mounting base 101. The controller displays, on the display screen 101a, the information indicating that the rotary plate 102 and the safety seat body 2 are engaged in place or the information indicating that the rotary plate 102 and the safety seat body 2 are not engaged, sent by the sensor 430, to remind the user of the engagement state of the safety seat body 2.

Although the linkage mechanism 200 and the linkage mechanism 200′ are different in structure, the linkage mechanism 200 and the linkage mechanism 200′ can achieve the same function. Therefore, a use process of the safety seat is described herein only by way of an example in which the linkage mechanism 200 is applied to the safety seat, and the use process is used as a reference to understand a use process of the safety seat to which the linkage mechanism 200′ is applied.

In the use process, when the rotary plate 102 rotates to the first rotation position (i.e., arranged in a rear-facing manner), as shown in FIG. 2, if the safety seat body 2 is to be disassembled from the safety seat base 1, the operating member 310 is operated so that the operating member 310 pulls the driving member 230 to move in the direction F2 through the pulling member 320. Then, the driving member 230 pushes the sliding member 210 to also move in the direction F1 to the unlocked position, so that the sliding member 210 applies no force to the locking hook 110, the fourth reset member 150 returns to its original form and drives the stopper 140 to rotate, and the third reset member 130 returns to its original form and drives the locking hook 110 to automatically pivot along the direction indicated by F3 in FIG. 8 to the releasing position, so that the locking hook 110 releases the locking for the engaging rod, allowing the engaging rod to move out of the engaging groove 103 of the locking hook 110 and allowing the safety seat body 2 to move away from the rotary plate 102. In this case, the locking hook 110 is held in the releasing position driven by the third reset member 130 and due to the fact that the stopper 140 abutting against the fixed member 120. The user releases the operating member 310, so that the sliding member 210 may move in the direction opposite to the direction indicated by F1 under the force of the second reset member 220 until the four blocking portions 211 respectively abut against the second pushing portions 116 of the four locking hooks 110 and are held in the unlocked position.

When the safety seat body 2 is required to be remounted on the safety seat base 1, the engaging rod is caused to push the stopper 140 to cause the stopper 140 to rotate and no longer push the fixed member 120, and then the engaging rod pushes the first pushing portion 115, so that the locking hook 110 rotates to be above the engaging rod, and the locking hook 110 is in the closed position, as shown in FIGS. 9 to 12. In this process, both the third reset member 130 and the fourth reset member 150 are deformed. The locking hook 110, when being in the closed position, is held in the closed position due to the engagement of the sliding member 210 with the second pushing portion 116 of the locking hook 110 driven by the second reset member 220, as shown in FIG. 8. At the same time, the sliding member 210 pushes the detector 410 through the push convex 213, so that the detector 410 moves in the direction F5 until the detection rib 411 is sensed by the sensor 430, as shown in FIG. 20. The sensor 430 then sends the information indicating that the rotary plate 102 and the safety seat body 2 are engaged in place, to the controller. The controller transmits or the information indicating that the rotary plate 102 and the safety seat body 2 are engaged in place to a mobile terminal such as a mobile phone of the user, or displays the information indicating that the rotary plate 102 and the safety seat body 2 are engaged in place on the display screen 101a of the mounting base 101, to remind the user.

When the rotary plate 102 rotates to the second rotation position (i.e., arranged in a forward-facing manner), as shown in FIG. 3, since the transmission rib 212 of the sliding member 210 rotates with the rotary plate 102 to a position away from the front end of the mounting base 101, that is, a position away from the driving member 230, in this case, even if the driving member 230 is driven by the operating assembly 300 to move along the direction indicated by F2, the driving member 230 cannot push the transmission rib 212 to move to cause the engaging mechanism 100 to be unlocked because the driving member 230 and the transmission rib 212 are spaced apart and incapable of contacting each other. In this way, the safety seat body 2 can only be removed when rotating to the first rotation position (i.e., being in the rear-facing state), which can prevent misuse caused by the infant safety seat body being in the forward-facing state when the user engages the infant safety seat body with the safety seat base 1 after the child safety seat body in the second rotation position (for example, in the forward-facing state) is removed, thereby improving the safety factor.

Certainly, specific arrangement positions and orientations of related parts of the above engaging mechanism 100 and the linkage mechanism 200 (or the linkage mechanism 200′) are only exemplary, and adaptive modifications to the above embodiments made by those skilled in the art according to common knowledge in the art based on the above still fall within the protection scope of the present disclosure. For example, the transmission rib 212 may also be positioned at a position in the lower cover 109 adjacent to the rear end thereof, the driving member 230 is correspondingly movably arranged at a position in the mounting base 101 adjacent to the front end thereof, and the sliding member 210 and the engaging mechanism 100 are correspondingly adjusted such that the movement of the sliding member 210 along the opposite direction of F1 can cause the engaging mechanism 100 to be unlocked. In short, any variants of the above embodiments are feasible as long as the engaging mechanism 100 can be unlocked when the rotary plate 102 is in the first rotation position, and the engaging mechanism 100 cannot be unlocked when the rotary plate 102 is in the second rotation position.

A technical effect of the above safety seat is described herein only by way of an example in which the linkage mechanism 200 is applied to the safety seat, and the technical effect is used as a reference to understand a technical effect of the safety seat to which the linkage mechanism 200′ is applied.

Specifically, in the above safety seat base 1, when the rotary plate 102 rotates to the first rotation position relative to the mounting base 101 (for example, to be in the rear-facing state), the driving member 230 in the linkage mechanism 200 is operable. Since the sliding member 210 at least partially protrudes from the mounting base 101 to be drivingly connected to the driving member 230, or the driving member 230 at least partially protrudes from the rotary plate 102 to be drivingly connected to the sliding member 210, the driving member 230 can directly drive the sliding member 210 to move while moving, so as to drive the engaging mechanism 100 to be unlocked. In this case, the safety seat base 1 is disengaged from the safety seat body 2, and the safety seat body 2 can be removed from the safety seat base 1. However, when the rotary plate 102 rotates to the second rotation position relative to the mounting base 101 (for example, to be in the forward-facing state), even if the driving member 230 is operated to move, since the driving member 230 does not abut against the sliding member 210, the engaging mechanism 100 remains locked, the safety seat base 1 and the safety seat body 2 remain engaged, and the safety seat body 2 cannot be disassembled from the safety seat base 1. With this arrangement, misuse caused by the infant safety seat being in the forward-facing state when the user engages the infant safety seat with the safety seat base 1 after the child safety seat in the second rotation position (for example, in the forward-facing state) is removed can be prevented, thereby improving the safety factor.

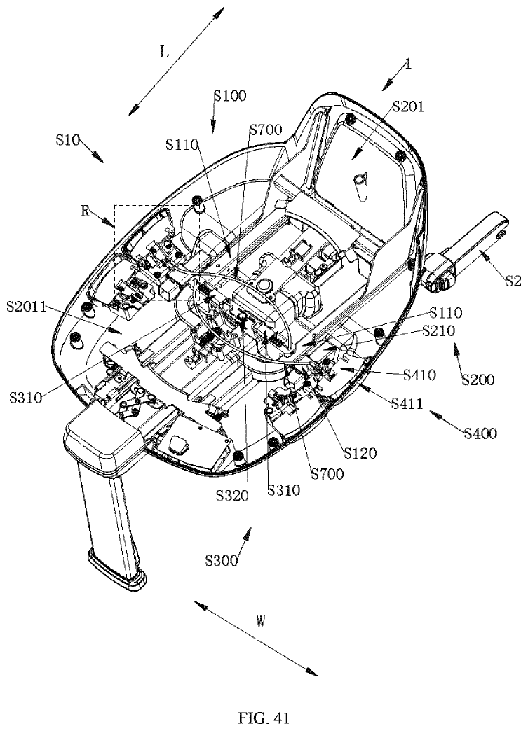

The safety seat base 1 according to the present application may also be connected with an adjustment mechanism for an ISOFIX connector. Generally, the ISOFIX connector is adapted for being attached to a connection component adapted thereto in a vehicle. The adjustment mechanism will be described in detail below with reference to FIGS. 41 to 49.

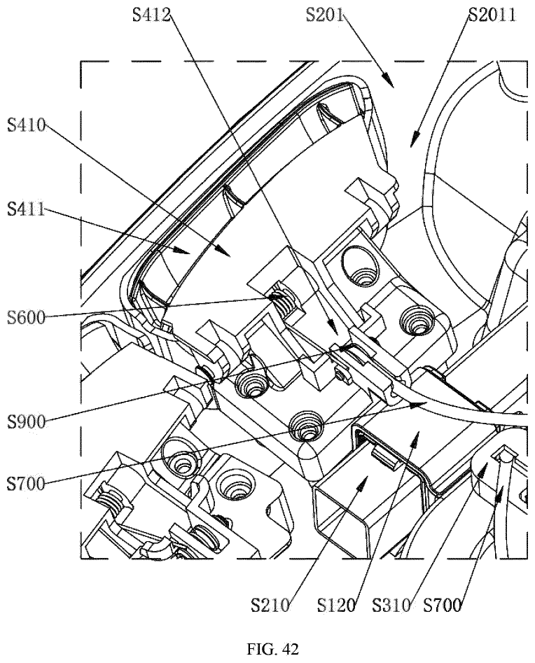

FIGS. 41 and 42 schematically illustrate a partial structure of the safety seat according to an embodiment of the present application. The safety seat according to the present application includes an adjustment mechanism S10 and a safety seat base 1, as shown in FIG. 41. The safety seat base 1 includes a base lower cover S201. The base lower cover S201 defines a mounting cavity S2011.

The adjustment mechanism S10 is positioned in the mounting cavity S2011 and includes a support S100. The support S100 is connected to the base lower cover S201. In addition, the adjustment mechanism S10 further includes a sliding rod assembly S200. The sliding rod assembly S200 includes two sliding rods S210. The two sliding rods S210 both extend along a length direction L of the safety seat (or the safety seat base 1), and may be spaced apart along a width direction of the safety seat (a direction W shown in FIG. 41). One end of each sliding rod S210 is slidably connected to the support S100 and releasably locked with respect to the support S100, and the other end of each sliding rod S210 is connected to the ISOFIX connector S2 such as an ISOFIX connecting rod. The ISOFIX connector S2 is adapted for being attached to the connection component adapted thereto in the vehicle.

Since the ISOFIX connector S2 is slidably connected to the support S100 of the safety seat through the sliding rod S210, a distance between a tip end of the ISOFIX connector S2 and the support S100 (i.e., a length of the ISOFIX connector S2 extending out of the support S100) can be defined by locking the sliding rod S210 to the support S100, and the distance between the tip end of the ISOFIX connector S2 and the support S100 can be adjusted by releasing the sliding rod S210 from the support S100. In some embodiments, the connection component adapted to the ISOFIX connector S2 in the vehicle, such as an ISOFIX snap ring, may be arranged in a vehicle seat. In this way, the ISOFIX connector S2 can be attached to the vehicle seat, so that the safety seat can be mounted to the vehicle seat.

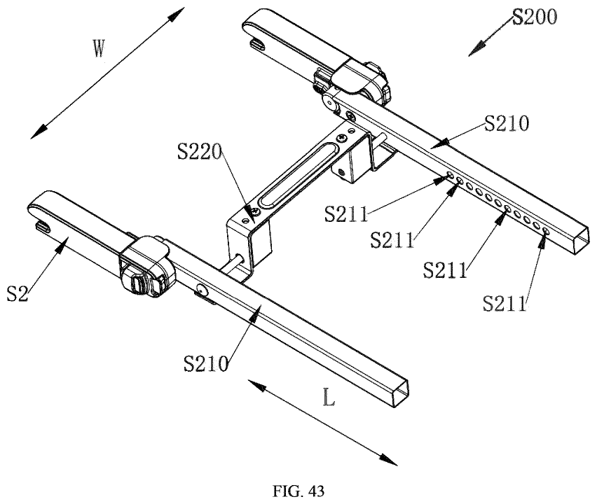

In some embodiments, referring to FIG. 43, the sliding rod assembly S200 further includes a connector S220. The two sliding rods S210 are both connected to the connector S220. In this embodiment, the connector S220 is arranged between the two sliding rods S210, and the connector S220 is formed by extending one of the sliding rods S210 to the other of the sliding rods S210. Synchronous sliding of the two sliding rods S210 can be realized by connecting the two sliding rods S210 together through the connector S220. The connector S220 is a connecting sheet or a connecting rod, such as a connecting iron sheet or a connecting iron rod.

In some embodiments, referring to FIGS. 41 and 42, the support S100 further includes two sliding sleeves S120 corresponding to the two sliding rods S110. The two sliding sleeves S120 are positioned on two opposite sides of the support S100. Each of the two sliding sleeves S120 is provided with a through hole (not shown), and one end of the corresponding sliding rod S210 passes through the through hole and is slidably connected to the support S100. In this way, sliding connection of the sliding rod S210 relative to the support S100 can be realized. Specifically, the sliding sleeve S120 may be connected to the support S100 in a manner such as welding, bolting, or engaging.

Referring to FIGS. 41 and 42, the adjustment mechanism S10 further includes an adjustment assembly S300 and an operating portion S400. The adjustment assembly S300 and the operating portion S400 are configured to control locking or unlocking between the sliding rod assembly S200 and the support S100. In this embodiment, the adjustment assembly S300 includes a linkage S320 and two engaging members S310. The two engaging members S310 may be spaced apart along the width direction of the safety seat. The two engaging members S310 are configured to releasably lock the sliding rod assembly S200 to the support S100, and the two engaging members S310 are movably connected to the linkage S320. The linkage S320 is adapted to drive one of the two engaging members S31 driven by the other of the two engaging members S310, so that the two engaging members S310 move synchronously to lock the sliding rod assembly S200 to the support S100 or release the sliding rod assembly S200 from the support S100.

In detail, a linkage effect of the linkage S320 may cause the two engaging members S310 to move synchronously to lock the sliding rod assembly S200 to the support S100 or release the sliding rod assembly S200 from the support S100 may be achieved in various ways. In some embodiments, referring to FIG. 41, when each of the two engaging members S310 moves, driven by the linkage S320, in a direction of locking the sliding rod assembly S200 to the support S100, the other of the two engaging members S310 can be driven to move in the direction of locking the sliding rod assembly S200 to the support S100, thereby locking the sliding rod assembly S200 to the support S100. When each of the two engaging members S310 moves, driven by the linkage S320, in a direction of releasing the sliding rod assembly S200 from the support S100, the other of the two engaging members S310 can be driven to move in the direction of releasing the sliding rod assembly S200 from the support S100, thereby releasing the sliding rod assembly S200 from the support S100.

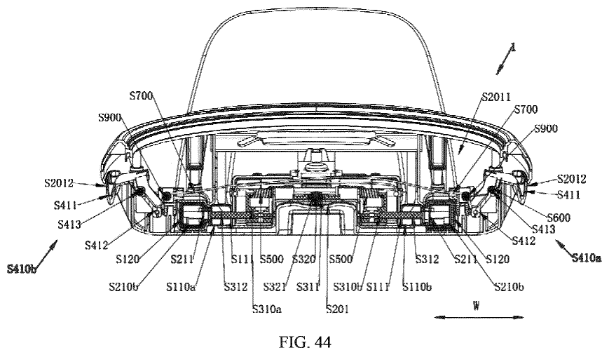

Referring to FIGS. 41 and 42, the operating portion S400 includes two operating members S410 connected to the two engaging members S310 respectively. Referring to FIG. 44, for ease of description, the two operating members S410 may be a first operating member S410a and a second operating member S410b, and the two engaging members S310 may be a first engaging member S310a and a second engaging member S310b. The first operating member S410a and the second operating member S410b may be spaced apart on two sides of the safety seat in the width direction thereof. In addition, the first operating member S410a and the second operating member S410b are configured on opposite sides of the linkage S320. Both the first engaging member S310a and the second operating member S410b are configured on the same side of the linkage S320, and the second engaging member S310b and the first operating member S410a are configured on the same side of the linkage S320.

The operating portion S400 is configured to operate either of the first operating member S410a and the second operating member S410b, which may cause the two engaging members S310 (i.e., the first engaging member S310a and the second engaging member S310b) to release the sliding rod assembly S200 from the support S100 synchronously. In this way, in a manner of operating either of the first operating member S410a and the second operating member S410b, and by means of transmission of the linkage S320, the two engaging members S310 (i.e., the first engaging member S310a and the second engaging member S310b) can be driven to move synchronously to release the sliding rod assembly S200 from the support S100, thereby realizing unlocking between the safety seat and the ISOFIX connector S2. The unlocking operation is simple and user-friendly and has a simple structure and low manufacturing costs.

However, the present application is not limited to the above embodiments. In another embodiment, the operating portion S400 may also include only one operating member S410. Since the two engaging members S310 can be linked with each other, even if there is only one operating member S410, the two engaging members S310 can be synchronously driven to synchronously move to lock the sliding rod assembly S200 to the support S100 or release the sliding rod assembly S200 from the support S100. The operating member S410 may be positioned on either side of the safety seat in the width direction thereof, or may be configured at another position according to an actual requirement, which is not limited in the present application.

In some embodiments, referring to FIG. 44, the adjustment assembly S300 further includes two elastic members S500 respectively corresponding to the two engaging members S310. Each of the two elastic members S500 is adapted to bias the respective engaging member S310 to cause the engaging member S310 to always have a tendency to move in a direction of locking the sliding rod assembly S200 to the support S100.

In this way, when the user does not operate the first operating member S410a and the second operating member S410b, the engaging member S310 is driven by the elastic action of the elastic member S500 so that the engaging member S310 always has a tendency to move in the direction of locking the sliding rod assembly S200 to the support S100, which can ensure that the sliding rod assembly S200 is always locked to the support S100 when no external force acts on the first operating member S410a and the second operating member S410b, thereby maintaining a length of the ISOFIX connector S2 protruding from an outer surface of the lower base cover S201.

It is easy to understand that when either of the first operating member S410a and the second operating member S410b is operated, there is a need to overcome an elastic force of the elastic member S500 so that the two engaging members S310 release the sliding rod assembly S200 from the support S100. When the external force acting on the first operating member S410a and the second operating member S410b is removed, an elastic restoring force of the elastic member S500 drives the engaging member S310 to lock the sliding rod assembly S200 to the support S100. In an optional embodiment, the elastic member S500 is a spring. Preferably, the elastic member S500 is a coil spring.

In some embodiments, the safety seat base 1, particularly the base lower cover S201, is provided with at least one mounting port in communication with the mounting cavity. The at least one mounting port is positioned on at least one side of the safety seat and corresponds to the operating portion S400. The operating portion S400 extends out of the at least one mounting port for a user to operate. Referring to FIGS. 41 and 44, when the operating portion S400 includes the first operating member S410a and the second operating member S410b, the base lower cover S201 is provided with two mounting ports S2012 in communication with the mounting cavity S2011. The two mounting ports S2012 are positioned on two opposite side of the safety seat and respectively correspond to the first operating member S410a and the second operating member S410b. In detail, the first operating member S410a and the second operating member S410b respectively extend out of the two mounting ports S2012 for a user to operate. In this way, the unlocking between the ISOFIX connector S2 and the safety seat can be realized when the user operates either of the first operating member S410a and the second operating member S410b outside the safety seat, which is easy to operate and easy to use.

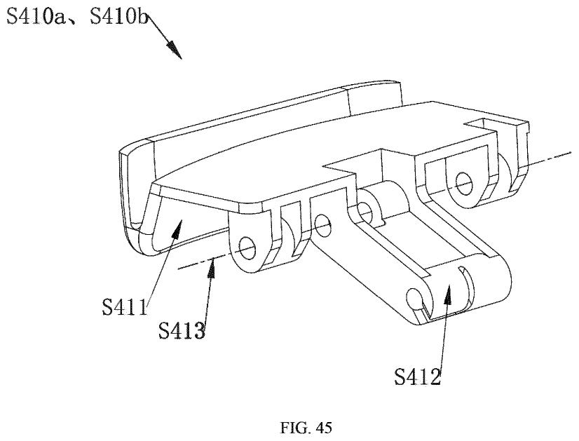

Specifically, referring to FIGS. 44 and 45, each of the first operating member S410a and the second operating member S410b is pivotably arranged. Further, each of the first operating member S410a and the second operating member S410b is configured to: be pivotable between a reset position and a pressed position; cause the respective engaging member S310 to move in the direction of releasing the sliding rod assembly S200 from the support S100 in the case of pivoting from the reset position to the pressed position; and cause the respective engaging member S310 to move in the direction of locking the sliding rod assembly S200 to the support S100 in the case of pivoting from the pressed position to the reset position. In this way, when the user presses one of the first operating member S410a and the second operating member S410b to pivot it from the reset position to the pressed position, the corresponding engaging member S310 can be driven to move in the direction of releasing the sliding rod assembly S200 from the support S100, and the other engaging member S310 synchronously moves in the direction of releasing the sliding rod assembly S200 from the support S100 driven by the linkage S320, thereby releasing the sliding rod assembly S200 from the support S100, so that the length of the ISOFIX connector S2 protruding from the safety seat base 1 is adjustable. When the user removes the pressing force to allow the one of the first operating member S410a and the second operating member S410b as described above to pivot from the pressed position to the reset position, the corresponding engaging member S310 moves in the direction of locking the sliding rod assembly S200 to the support S100, and the other engaging member S310 synchronously moves in the direction of locking the sliding rod assembly S200 to the support S100 driven by the linkage S320, thereby locking the sliding rod assembly S200 to the support S100, so as to fix the length of the ISOFIX connector S2 protruding from the safety seat base 1.

In some embodiments, referring to FIG. 42, the adjustment assembly S300 further includes two elastic reset members S600 respectively corresponding to the two operating members S410. Each of the two elastic reset members S600 is adapted to bias the corresponding operating member S410 to cause the operating member S410 to always have a tendency to pivot from the pressed position to the reset position. In this way, when the user applies no force to either of the two operating members S410, the operating member S410 is driven by the elastic action of the elastic reset member S600 so that the operating member S410 always have a tendency to pivot from the pressed position to the reset position, which can ensure that the sliding rod assembly S200 is always locked to the support S100 when no external force acts on the operating member S410, so that the length of the ISOFIX connector S2 protruding from the safety seat base 1 is constant.

In addition, it is easy to understand that there is a need to overcome the elastic force of the elastic reset member S600 when the user presses either of the two operating members S410 to pivot it from the reset position to the pressed position. The elastic restoring force of the elastic reset member S600 drives one of the two operating members S410 to pivot from the pressed position to the reset position when the user removes the pressing force. In an optional embodiment, the elastic reset member is a spring. Preferably, the elastic reset member is a torsion spring.

It should be understood herein that the operating portion S400 and the operating assembly 300 are spaced apart on two sides of the safety seat (or the safety seat base) in the width direction thereof, as shown in FIGS. 32 and 41. The operating portion S400 and the operating assembly 300 may each have two operating members. In this case, one operating member of the operating assembly 300, and for example, the first operating member S410a may be arranged on one side of the safety seat (or the safety seat base), while the other operating member of the operating assembly 300, and for example, the second operating member S410b may be arranged on the other side of the safety seat (or the safety seat base). In some embodiments, the operating portion S400 and the operating assembly 300 may each have one operating member. In this case, the operating member of the operating portion S400 and the operating member of the operating assembly 300 may be arranged on one side of the safety seat (or the safety seat base), or arranged on two sides of the safety seat (or the safety seat base) respectively. Specific arrangement of the operating portion S400 and the operating assembly 300 is not limited thereto, which may be adaptively adjusted as required, as long as the operating portion S400 and the operating assembly 300 can achieve the respective functions as described above.

In some embodiments, referring to FIGS. 41 and FIG. 44, the adjustment assembly S300 further includes two pulling members S700. The pulling members S700 each includes one of a steel rope, an iron rope, a plastic pulling rope, a polymer material pulling rope, and an organic fiber rope or a combination thereof. The first operating member S410a and the second operating member S410b are connected to the two engaging members S310 respectively via the two pulling members S700. By means of a pulling effect of the pulling member S700, the first operating member S410a and the second operating member S410b, when pivoting between the reset position and the pressed position, can drive the corresponding engaging member S310 to move in the direction of releasing the sliding rod assembly S200 from the support S100 or in the direction of locking the sliding rod assembly S200 to the support S100.

In some embodiments, referring to FIG. 45, each of the first operating member S410a and the second operating member S410b includes an operating end S411 and a pulling end S412 connected to the corresponding pulling member S700. The operating end S411 and the pulling end S412 are arranged at two opposite ends of the operating member S410 with respect to a pivot axis S413 respectively. The operating end S411 is configured to provide a point of force application for the user, which is convenient to the user to press the first operating member S410a and the second operating member S410b. The operating end S411 and the pulling end S412 are arranged at two opposite ends of the operating member S410 respectively with respect to the pivot axis S413, so that the pulling end S412 can be driven to pivot when the user presses the operating end S411. The pulling end S412 drives the pulling member S700 connected to the pulling end S412 to move, and drives the engaging member S310 to move by means of the pulling effect of the pulling member S700.

In this embodiment, the operating member S410 and the engaging member S310 that are connected to each pulling member S700 are positioned on two opposite sides of the linkage S320 respectively. As shown in FIG. 44, for example, one pulling member S700 is connected to the first operating member S410a and the first engaging member S310a, and the other pulling member S700 is connected to the second operating member S410b and the second engaging member S310b. Accordingly, when the operating end S411 of the first operating member S410a is pressed, the pulling member S700 drives the first engaging member S310a to move toward the linkage S320. The movement of the first engaging member S310a may drive the linkage S320 to synchronously drive the second engaging member S310b to move toward the linkage S320. In other words, in this embodiment, when the first operating member S410a is pressed, through the pulling member S700 and the linkage S320, the first engaging member S310a and the second engaging member S310b can be driven to approach each other to release the locking between the support S100 and the sliding rod assembly S200. Similarly, the same result can also be achieved when the second operating member S410b is pressed, and details thereof are not described herein again.

In some other embodiments, the operating end S411 and the pulling end S412 may also be arranged at the same end of the operating member S410 with respect to the pivot axis S413, as long as the pulling end S412 can be driven to pivot when the user presses the operating end S411, and then the pulling member S700 connected to the pulling end S412 is driven to move.

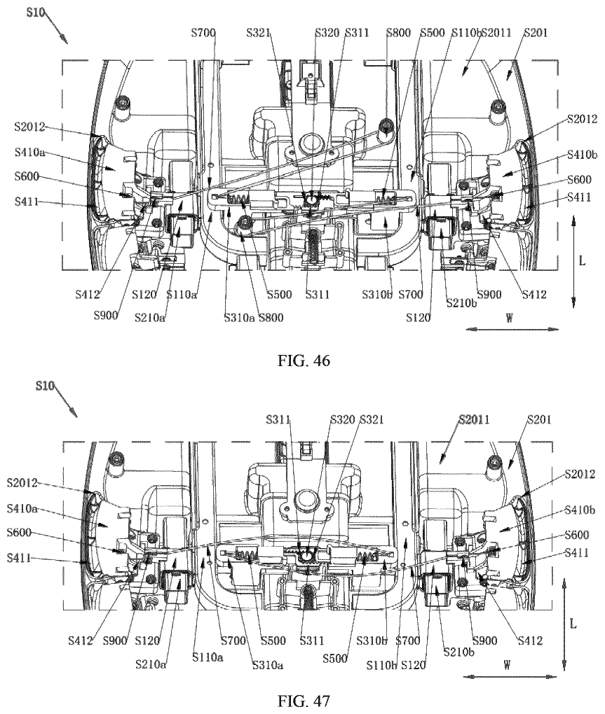

In some embodiments, referring to FIG. 46, the adjustment assembly S300 further includes two steering posts S800. The two steering posts S800 are in one-to-one correspondence to the two pulling members S700. Each of the two pulling members S700 is arranged around the corresponding steering post S800 to change a pulling direction of the pulling member S700. In different embodiments, referring to FIGS. 46 and 47, positions of the first operating member S410a and the second operating member S410b relative to the corresponding engaging member S310 may be different. The steering post S800 is arranged to change the pulling direction of the pulling member S700, so that even in different arrangements, the first operating member S410a or the second operating member S410b can drive the corresponding engaging member S310 to move in a desired direction.

Further, in the embodiment of FIG. 46, the first operating member S410a and the first engaging member S310a are both positioned on one side of the linkage S320. That is, the first engaging member S310a is closer to the first operating member S410a. In addition, the second operating member S410b and the second engaging member S310b are both positioned on the other side of the linkage S320. That is, the second engaging member S310b is closer to the second operating member S410b.

Specifically, referring to FIGS. 46 and 47, in some embodiments, the first operating member S410a and the second operating member S410b as well as the two engaging members S310 are spaced apart along the width direction of the safety seat. The first operating member S410a and the second operating member S410b are arranged in the two mounting ports S2012 respectively. The two engaging members S310 (the first engaging member S310a and the second engaging member S310b) are arranged in the mounting cavity S2011. The support S100 includes a first mounting rack S110a and a second mounting rack S110b. The first mounting rack S110a is releasably locked to the first sliding rod S210a, and the second mounting rack S110b is releasably locked to the second sliding rod S210b. The first sliding rod S210a and the first mounting rack S110a are arranged between the first operating member S410a and the first engaging member S310a. The second sliding rod S210b and the second mounting rack S110b are arranged between the second operating member S410b and the second engaging member S310b.

In an embodiment, referring to FIG. 46, the first operating member S410a is connected to the first engaging member S310a adjacent to one side where the first operating member S410a is arranged via the pulling member S700. The second operating member S410b is connected to the second engaging member S310b adjacent to one side where the second operating member S410b is arranged via the pulling member S700. In this case, the adjustment assembly S300 is provided with the steering post S800. In this way, when the first operating member S410a pivots from the reset position to the pressed position, the pulling end S412 of the first operating member S410a moves in a direction away from the second operating member S410b, and the pulling end S412 of the first operating member S410a drives the pulling member S700 to move in the direction away from the second operating member S410b. The pulling direction of the pulling member S700 can be changed due to the existence of the steering post S800, so that the pulling member S700 can drive the first engaging member S310a to move in a direction approaching to the second operating member S410b and away from the first operating member S410a, thereby driving the first engaging member S310a to move in a direction away from the first sliding rod S210a and the first mounting rack S110a. Therefore, the first engaging member S310a can be disengaged from the first sliding rod S210a and the first mounting rack S110a so that the first sliding rod S210a can be released from the first mounting rack S110a. Meanwhile, the linkage S320 enables the second engaging member S310b to synchronously move in the direction away from the second operating member S410b, so that the second engaging member S310b can be disengaged from the second sliding rod S210b and the second mounting rack S110b to release the second sliding rod S210b from the second mounting rack S110b, thereby realizing the unlocking between the support S100 and the sliding rod assembly S200. As can be seen, the steering post S800 is arranged to control the pulling direction of the pulling member S700, so that even in different arrangements, the first operating member S410a or the second operating member S410b can drive the corresponding engaging member S310 to move in a desired direction.

In another embodiment, referring to FIG. 47, the first operating member S410a is connected to the second engaging member S310b adjacent to one side where the second operating member S410b is arranged via the pulling member S700. The second operating member S410b is connected to the first engaging member S310a adjacent to one side where the first operating member S410a is arranged via the pulling member S700. In this case, the adjustment assembly S300 is not provided with the steering post S800. In this way, when the first operating member S410a pivots from the reset position to the pressed position, the pulling end S412 of the first operating member S410a moves in the direction away from the second operating member S410b, so that the pulling member S700 drives the second engaging member S310b to move in the direction away from the second operating member S410b. That is, the second engaging member S310b moves in a direction away from the second sliding rod S210b and the second mounting rack S110b, so that the second engaging member S310b can be disengaged from the second sliding rod S210b and the second mounting rack S110b to release the second sliding rod S210b can be released from the second mounting rack S110b. Meanwhile, the linkage S320 enables the first engaging member S310a to synchronously move in a direction away from the first operating member S410a, so that the first engaging member S310a can be disengaged from the first sliding rod S210a and the first mounting rack S110a to release the first sliding rod S210a from the first mounting rack S110a, thereby realizing the unlocking between the support S100 and the sliding rod assembly S200.

In some embodiments, referring to FIGS. 42 and 44, the adjustment assembly S300 further includes two rolling members S900. The two pulling members S700 are arranged on the two rolling members S900 respectively. In this way, when the pulling member S700 moves, the pulling member S700 drives the rolling member S900 to roll through friction. A synchronous rolling effect of the rolling member S900 and the pulling member S700 enables the movement of the pulling member S700 to be smoother. The rolling member S900 includes a roller. The rolling member S900 is rotatably arranged on the base lower cover S201.

In some embodiments, referring to FIGS. 44, 46, and 47, the linkage S320 is rotatably arranged, and an extending direction of a rotating shaft of the linkage S320 is different from a moving direction of the sliding rod S210, and also different from moving directions of the two engaging members S310. In this embodiment, the moving direction of the sliding rod S210 is roughly parallel to the length direction L of the safety seat (or the safety seat base 1), and the moving directions of the two engaging members S310 are roughly parallel to the width direction W of the safety seat (or the safety seat base 1). In addition, in this embodiment, the two engaging members S310 and the linkage S320 are mainly driven by meshing, but which is not limited thereto in the present application. In other embodiments, the two engaging members S310 and the linkage S320 may also be linked with each other in other transmission manners.

In this embodiment, each of the two engaging members S310 is provided with a first meshing portion S311, and a periphery of the linkage S320 is provided with a second meshing portion S321 adapted to the first meshing portion S311. Each of the two engaging members S310 is movably connected to the linkage S320 by the respective first meshing portion S311 meshing with the second meshing portion S321. In this way, when one of the two engaging members S310 is driven by the operating portion S400 to move, the first meshing portion S311 of this engaging member S310 moves, and drives the linkage S320 to rotate through mutual meshing between the first meshing portion S311 and the second meshing portion S321. The linkage S320, while rotating, may drive the first meshing portion S311 of the other of the two engaging members S310 to move, by means of mutual meshing between the second meshing portion S321 and the first meshing portion S311 of the other of the two engaging members S310, thereby driving the other of the two engaging members S310 to move, which thus realizes synchronously movement of the two engaging members S310. Specifically, the first meshing portion S311 is a rack, the linkage S320 is a gear, and the second meshing portion S321 is a tooth of the gear. In an optional embodiment, the linkage S320 is rotatably connected to the base lower cover S201.

Specifically, referring to FIGS. 46 and 47, the two first meshing portions S311 of the two engaging members S310 are positioned on two opposite sides of the linkage S320 respectively, and meshed with the second meshing portion S321. The first meshing portions S311 of the two engaging members S310 and the linkage S320 are positioned between the first sliding rod S210a and the first mounting rack S110a and between the second sliding rod S210b and the second mounting rack S110b, respectively. The first engaging member S310a is positioned on a side adjacent to the first sliding rod S210a and the first mounting rack S110a. The first engaging member S310a is configured to releasably lock the first sliding rod S210a to the first mounting rack S110a. The second engaging member S310b is positioned on a side adjacent to the second sliding rod S210b and the second mounting rack S110b. The second engaging member S310b is configured to releasably lock the second sliding rod S210b to the second mounting rack S110b.

In this way, when the first engaging member S310a moves in a direction approaching the first sliding rod S210a and the first mounting rack S110a to lock the first sliding rod S210a to the first mounting rack S110a, through mutual meshing between the first meshing portion S311 of the first engaging member S310a and the second meshing portion S321 of the linkage S320, rotation of the linkage S320, and mutual meshing between the second meshing portion S321 and the first meshing portion S311 of the second engaging member S310b, the second engaging member S310b can be driven to move in a direction approaching the second sliding rod S210b and the second mounting rack S110b to lock the second sliding rod S210b to the second mounting rack S110b. When the first engaging member S310a moves in the direction away from the first sliding rod S210a and the first mounting rack S110a to release the first sliding rod S210a from the first mounting rack S110a, through the mutual meshing between the first meshing portion S311 of the first engaging member S310a and the second meshing portion S321, the rotation of the linkage S320, and the mutual meshing between the second meshing portion S321 and the first meshing portion S311 of the second engaging member S310b, the second engaging member S310b can be driven to move in the direction away from the second sliding rod S210b and the second mounting rack S110b to release the second sliding rod S210b from the second mounting rack S110b.

Similarly, when the second engaging member S310b moves in the direction approaching the second sliding rod S210b and the second mounting rack S110b to lock the second sliding rod S210b to the second mounting rack S110b, through the mutual meshing between the first meshing portion S311 of the second engaging member S310b and the second meshing portion S321, the rotation of the linkage S320, and the mutual meshing between the second meshing portion S321 and the first meshing portion S311 of the first engaging member S310a, the first engaging member S310a can be driven to move in the direction approaching the first sliding rod S210a and the first mounting rack S110a to lock the first sliding rod S210a to the first mounting rack S110a. When the second engaging member S310b moves in the direction away from the second sliding rod S210b and the second mounting rack S110b to release the second sliding rod S210b from the second mounting rack S110b, through the mutual meshing between the first meshing portion S311 of the second engaging member S310b and the second meshing portion S321, the rotation of the linkage S320, and the mutual meshing between the second meshing portion S321 and the first meshing portion S311 of the first engaging member S310a, the first engaging member S310a can be driven to move in the direction away from the first sliding rod S210a and the first mounting rack S110a to release the first sliding rod S210a from the first mounting rack S110a. Therefore, driven by one of the two engaging members S310, the other of the two engaging members S310 can be driven by the linkage S320 to move, so that the two engaging members S310 synchronously move to lock the sliding rod assembly S200 to the support S100 or release the sliding rod assembly S200 from the support S100.

In some embodiments, referring to FIG. 44, the two engaging members S310 correspond to the two sliding rods S210 respectively. Each of the two engaging members S310 (i.e., the first engaging member S310a and the second engaging member S310b) is provided with an engaging portion S312. the engaging portion S312 is configured to be releasably engaged with the corresponding sliding rod S210 and the support S100. In this way, the engaging member S310 is releasably engaged with the corresponding sliding rod S210 and the support S100 through the engaging portion S312, thereby releasably locking the sliding rod assembly S200 to the support S100. The engaging portion S312 and the engaging member S310 may be integrally formed, or may be two separate parts connected to each other.

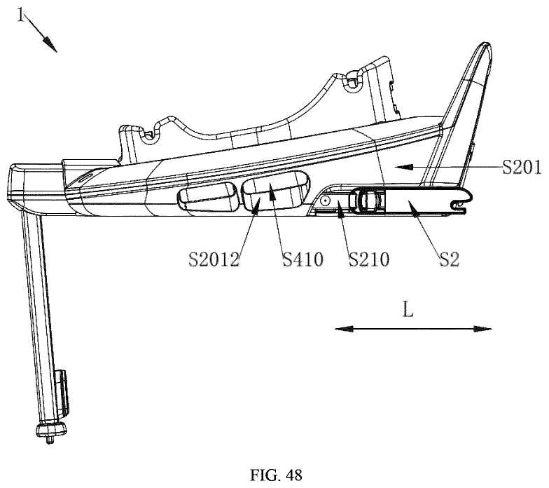

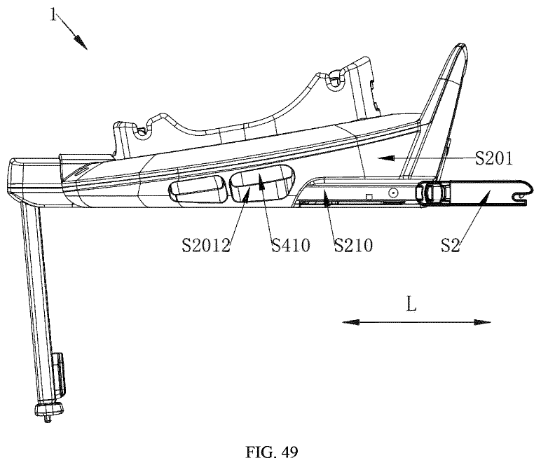

Specifically, referring to FIG. 44, the engaging portion S312 includes an engaging pin, and the support S100 is provided with first engaging holes S111 corresponding to the two engaging members S310. Optionally, the two first engaging holes S111 are provided in the two mounting racks S110 respectively. Referring to FIGS. 43 and 44, each of the two sliding rods S210 is provided with a plurality of second engaging holes S211. All the second engaging holes S211 provided in each sliding rod S210 may be spaced apart from each other along the length direction of the safety seat (e.g., the direction L in FIG. 43). The engaging pin is adapted to pass through the corresponding first engaging hole S111 and be inserted into one of the second engaging holes S211 in the corresponding sliding rod S210, so as to releasably lock the corresponding sliding rod S210 to the support S100. In addition, each of the two sliding rods S210 is provided with the plurality of second engaging holes S211, so that the engaging pin can be selectively inserted into one of the second engaging holes S211, and the support S100 is connected to a different position of the sliding rod assembly S200. Then, the relative position between the safety seat base 1 and the ISOFIX connector S2 is variable, so as to adjust the length of the ISOFIX connector S2 protruding from the safety seat base 1. A change in the relative position between the ISOFIX connector S2 and the safety seat base 1 may be understood with reference to FIGS. 48 and 49. Through the adjustment mechanism S10 according to the embodiments of the present application, the relative positions between the two ISOFIX connectors S2 and the safety seat base 1 arranged in the width direction W of the safety seat base 1 can be synchronously adjusted, thereby adjusting the length of the ISOFIX connector S2 protruding from an outer surface of the safety seat base 1. The adjustment mechanism S10 according to the embodiments of the present application has a simple structure, is convenient to use, and can reduce costs.

According to an aspect of the present disclosure, a safety seat base is provided. A safety seat body is mounted to the safety seat base, and the safety seat base includes: a mounting base; a rotary plate rotatably arranged on the mounting base and having a first rotation position and a second rotation position; an engaging mechanism configured to engage the rotary plate with the safety seat body; and a linkage mechanism. The linkage mechanism includes: a driving member slidably arranged on the mounting base; and a sliding member slidably arranged on the rotary plate. The sliding member at least partially protrudes into the mounting base to abut against the driving member, or the driving member at least partially protrudes into the rotary plate to abut against the sliding member. When the rotary plate rotates to the first rotation position, the driving member is operable to move and drive the sliding member to slide, so as to drive the engaging mechanism to be unlocked.

In the above safety seat base, when the rotary plate rotates to the first rotation position relative to the mounting base (for example, to be in the rear-facing state), the driving member in the linkage mechanism is operable. Since the sliding member at least partially protrudes into the mounting base to be drivingly connected to the driving member, or the driving member at least partially protrudes into the rotary plate to be drivingly connected to the sliding member, the driving member can directly drive the sliding member to move while moving, so as to drive the engaging mechanism to be unlocked. In this case, the safety seat base is disengaged from the safety seat body, and the safety seat body can be removed from the safety seat base. However, when the rotary plate rotates to the second rotation position relative to the mounting base (for example, to be in the forward-facing state), even if the driving member is operated to move, since the driving member does not abut against the sliding member, the engaging mechanism still remains locked, the safety seat base and the safety seat body remain engaged, and the safety seat body cannot be disassembled from the safety seat base. With this arrangement, misuse caused by infant safety seat being in the forward-facing state when the user engages the infant safety seat with the safety seat base after the child safety seat in the second rotation position (for example, in the forward-facing state) is removed can be prevented, thereby improving the safety factor.

In an embodiment of the present disclosure, when the rotary plate rotates to the second rotation position, the driving member is incapable of driving the sliding member to slide, and incapable of driving the engaging mechanism to be unlocked.

In an embodiment of the present disclosure, the sliding member includes a transmission rib protruding into the mounting base, the driving member is provided with a pushing groove. When the rotary plate rotates to the first rotation position, the transmission rib is capable of abutting against a groove wall of the pushing groove.

In an embodiment of the present disclosure, when the rotary plate rotates to the second rotation position, the transmission rib and the driving member are spaced apart and incapable of contacting each other.

In an embodiment of the present disclosure, the linkage mechanism further includes a reinforcing pin, the reinforcing pin being fixedly inserted into the transmission rib.

In an embodiment of the present disclosure, the linkage mechanism further includes a linkage member, the linkage member being pivotally connected to the rotary plate. When the rotary plate rotates to the first rotation position, the driving member is operable to drive the linkage member to rotate, and the linkage member is rotated to drive the sliding member to slide to drive the engaging mechanism to be unlocked.

In an embodiment of the present disclosure, the linkage member includes a first end and a second end. When the rotary plate rotates to the first rotation position, the first end is capable of abutting against the sliding member, and the second end is capable of abutting against the driving member.

In an embodiment of the present disclosure, the sliding member is provided with a first pushing groove, the driving member is provided with a second pushing groove, the first end is positioned in the first pushing groove. When the rotary plate rotates to the first rotation position, the second end is positioned in the second pushing groove, the first end is capable of abutting against a groove wall of the first pushing groove, and the second end is capable of abutting against a groove wall of the second pushing groove.

In an embodiment of the present disclosure, when the rotary plate rotates to the second rotation position, the second end and the driving member are spaced apart and incapable of contacting each other.

In an embodiment of the present disclosure, the linkage mechanism further includes a fifth reset member, two ends of the fifth reset member abutting against the driving member and the mounting base respectively. The fifth reset member always causes the driving member to move in a direction opposite to a direction in which the sliding member is driven to unlock the engaging mechanism.

In an embodiment of the present disclosure, the safety seat base further includes an indication mechanism. The indication mechanism includes a detector and a sensor. The detector is slidably arranged on the rotary plate, the sensor is arranged on the mounting base. The sliding member, when sliding, is capable of pushing the detector to move in a direction intersecting with a sliding direction of the sliding member, so that the detector is sensed by the sensor and outputs information indicating that the rotary plate and the safety seat body are engaged in place; or so that the detector is not sensed by the sensor and outputs information indicating that the rotary plate and the safety seat body are not engaged in place.

In an embodiment of the present disclosure, the indication mechanism further includes a controller and a display screen that are arranged on the mounting base. The sensor is configured to transmit the information indicating that the rotary plate and the safety seat body are engaged in place to the controller, and the controller is configured to display the information indicating that the rotary plate and the safety seat body are engaged in place on the display screen.

Or, the indication mechanism further includes a controller arranged on the mounting base. The sensor is configured to transmit the information indicating that the rotary plate and the safety seat body are engaged in place to the controller, and the controller is configured to transmit the information indicating that the rotary plate and the safety seat body are engaged in place to a mobile terminal.

In an embodiment of the present disclosure, the indication mechanism further includes a first reset member. The first reset member is arranged between the detector and the rotary plate. The first reset member always causes the detector to rotate in a direction away from the mounting base.

In an embodiment of the present disclosure, the sliding member is provided with a push convex protruding in the direction intersecting with the sliding direction of the sliding member. The detector is provided with a push block capable of abutting against the push convex. The sliding member, when sliding, pushes the push block to drive the detector to move in the direction intersecting with the sliding direction of the sliding member, through the push convex.

In an embodiment of the present disclosure, the detector is provided with a detection rib. The detection rib is capable of protruding into the mounting base and being detected by the sensor when the detector moves in the direction intersecting with the sliding direction of the sliding member.

In an embodiment of the present disclosure, the engaging mechanism includes a locking hook pivotally connected to the rotary plate and having a releasing position and a closed position. The locking hook is configured to be separably engaged with the safety seat body, and the sliding member is capable of holding the locking hook in the closed position.

In an embodiment of the present disclosure, the linkage mechanism further includes a second reset member. Two ends of the second reset member are connected to the sliding member and the rotary plate respectively. The second reset member always causes the sliding member to move in a direction in which the locking hook is held in the closed position.

In an embodiment of the present disclosure, the engaging mechanism further includes a third reset member. Two ends of the third reset member abuts against the rotary plate and the locking hook respectively. The third reset member always causes the locking hook to rotate to the releasing position.

In an embodiment of the present disclosure, the engaging mechanism further includes a fixed member, a stopper, and a fourth reset member. The fixed member is fixedly connected to the locking hook. One end of the stopper is pivotally connected to the rotary plate, the other end of the stopper is capable of abutting against the fixed member to hold the locking hook in the releasing position. Two ends of the fourth reset member abuts against the stopper and the rotary plate respectively. The fourth reset member always causes the stopper to rotate in a direction of abutting against the fixed member.

In an embodiment of the present disclosure, the safety seat base further includes an operating assembly. The operating assembly is connected to the driving member, and the operating assembly is operable to act on the driving member to drive the engaging mechanism to be unlocked.

In an embodiment of the present disclosure, the operating assembly includes an operating member and a pulling member. The operating member is arranged on the mounting base, the pulling member is connected between the operating member and the driving member. The operating member is operable to drive, through the pulling member, the driving member to move, so as to drive the engaging mechanism to be unlocked.

In an embodiment of the present disclosure, the operating member is pivotally connected to the mounting base, the operating member is operable to rotate relative to the mounting base so as to drive the driving member to move by the pulling member.

In an embodiment of the present disclosure, the operating assembly further includes a pivot shaft fixed to the mounting base. The operating member includes an operating portion, a pivot portion, and a first connecting portion. The pivot portion is pivotally connected to the pivot shaft. The operating portion and the first connecting portion are positioned on two sides of the pivot shaft respectively. Two ends of the pulling member are connected to the first connecting portion and the driving member respectively, and the operating portion is operable to pivot the operating member about the pivot shaft.

In an embodiment of the present disclosure, the operating assembly further includes a sixth reset member. The sixth reset member is arranged between the operating member and the mounting base. The sixth reset member always causes the operating member to rotate to a position where the operating member is not operated.

According to another aspect of the present disclosure, a safety seat is provided, the safety seat including a safety seat body and the safety seat base according to any one of the above embodiments. The safety seat body is an infant safety seat body or a child safety seat body.

According to yet another aspect of the present disclosure, an adjustment mechanism for an ISOFIX connector is provided. The ISOFIX connector is adapted for being attached to a connection component in a vehicle adapted to the ISOFIX connector. The adjustment mechanism includes: a support configured to connect a base of a safety seat; a sliding rod assembly including two sliding rods, one end of each of the two sliding rods being slidably connected to the support and releasably locked with respect to the support, the other end of each of the two sliding rods being connected to the ISOFIX connector; an adjustment assembly including a linkage and two engaging members, the two engaging members being movably connected to the linkage, the linkage being adapted to drive one of the two engaging members driven by the other of the two engaging members, so that the two engaging members move synchronously to lock the sliding rod assembly to the support or release the sliding rod assembly from the support; and an operating portion configured to drive either of the two engaging members, so that the two engaging members synchronously release the sliding rod assembly from the support or lock the sliding rod assembly to the support.

According to the adjustment mechanism of the present disclosure, synchronous locking or unlocking of the engaging portions on the two sides of the safety seat can be realized through a simple structure, reducing the manufacturing costs.

In an embodiment of the present disclosure, driven by the linkage, one of the two engaging members, when moving in a direction of locking the sliding rod assembly to the support or in a direction of releasing the sliding rod assembly from the support, is capable of driving the other of the two engaging members to move in the direction of locking the sliding rod assembly to the support or in the direction of releasing the sliding rod assembly from the support.

In an embodiment of the present disclosure, the operating portion includes a first operating member and a second operating member respectively connected to the two engaging members. The operating portion operates either of the first operating member and the second operating member to drive a corresponding one of the two engaging members, and each of the first operating member and the second operating member is pivotably arranged.

In an embodiment of the present disclosure, each of the first operating member and the second operating member is configured to: be pivotable between a reset position and a pressed position; cause the corresponding engaging member to move in the direction of releasing the sliding rod assembly from the support in the case of pivoting from the reset position to the pressed position; and cause the corresponding engaging member to move in the direction of locking the sliding rod assembly to the support in the case of pivoting from the pressed position to the reset position.

In an embodiment of the present disclosure, the adjustment assembly further includes two pulling members, and the first operating member and the second operating member are connected to the two engaging members respectively via the two pulling members.

In an embodiment of the present disclosure, each of the two pulling members includes a steel rope.

In an embodiment of the present disclosure, each of the first operating member and the second operating member includes an operating end, and a pulling end connected to the corresponding pulling member. The operating end and the pulling end are arranged at two opposite ends of the operating member with respect to a pivot axis respectively.

In an embodiment of the present disclosure, the adjustment assembly further includes two steering posts. The two steering posts are in one-to-one correspondence to the two pulling members. Each of the two pulling members is arranged around the corresponding steering post to change a pulling direction of the pulling member.

In an embodiment of the present disclosure, the adjustment assembly further includes two rolling members. The two pulling members are arranged on the two rolling members respectively.

In an embodiment of the present disclosure, each of the two rolling members includes a roller.

In an embodiment of the present disclosure, the adjustment assembly further includes two elastic reset members respectively corresponding to the first operating member and the second operating member. Each of the two elastic reset members is adapted to bias the corresponding operating member to cause the operating member to always have a tendency to pivot from the pressed position to the reset position.

In an embodiment of the present disclosure, the two engaging members and the linkage are driven by meshing.

In an embodiment of the present disclosure, the linkage is rotatably arranged. An extending direction of a rotating shaft of the linkage is different from a moving direction of the sliding rod and also different from moving directions of the two engaging members.

In an embodiment of the present disclosure, each of the two engaging members is provided with a first meshing portion, the linkage is rotatably arranged, and a periphery of the linkage is provided with a second meshing portion adapted to the first meshing portion. Each of the two engaging members is movably connected to the linkage by the respective first meshing portion being meshed with the second meshing portion.

In an embodiment of the present disclosure, the two engaging members correspond to the two sliding rods respectively. Each of the two engaging members is provided with an engaging portion. The engaging portion is configured to be releasably engaged with the corresponding sliding rod and the support.

In an embodiment of the present disclosure, the engaging portion includes an engaging pin. The support is provided with two first engaging holes respectively corresponding to the two engaging members. Each of the two sliding rods is provided with a plurality of second engaging holes. The engaging pin is adapted to pass through the corresponding first engaging hole and be inserted into one of the second engaging holes in the corresponding sliding rod, so as to releasably lock the corresponding sliding rod to the support.

In an embodiment of the present disclosure, the first meshing portion is a rack, the linkage is a gear, and the second meshing portion is a tooth of the gear.

In an embodiment of the present disclosure, the sliding rod assembly further includes a connector, and the two sliding rods are both connected to the connector.

In an embodiment of the present disclosure, the connector is a connecting sheet or a connecting rod.

In an embodiment of the present disclosure, the adjustment assembly further includes two elastic members respectively corresponding to the two engaging members. Each of the two elastic members is adapted to bias the corresponding engaging member to cause the engaging member to always have a tendency to move in a direction of locking the sliding rod assembly to the support.

In an embodiment of the present disclosure, the support further includes two sliding sleeves respectively corresponding to the two sliding rods. The two sliding sleeves is positioned on two opposite sides of the support respectively. Each of the two sliding sleeves is provided with a through hole. One end of the corresponding sliding rod passes through the through hole and is slidably connected to the support.

According to still another aspect of the present disclosure, a safety seat is provided, the safety seat including a base and any of the adjustment mechanisms as described above. The base is connected to the support.

In an embodiment of the present disclosure, the base is provided with a mounting cavity and at least one mounting port in communication with the mounting cavity. The at least one mounting port is positioned on at least one side of the safety seat and corresponding to the operating portion. The operating portion extends out of the at least one mounting port for a user to operate.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1. A safety seat base, to which a safety seat body is mounted, and comprising:
a mounting base;
a rotary plate rotatably arranged on the mounting base and having a first rotation position and a second rotation position;
an engaging mechanism configured to engage the rotary plate with the safety seat body; and
a linkage mechanism comprising:
a driving member slidably arranged on the mounting base; and
a sliding member slidably arranged on the rotary plate;
wherein the sliding member at least partially protrudes into the mounting base to abut against the driving member, or the driving member at least partially protrudes into the rotary plate to abut against the sliding member; and when the rotary plate rotates to the first rotation position, the driving member is operable to move and drive the sliding member to slide, so as to drive the engaging mechanism to be unlocked.

2. The safety seat base according to claim 1, wherein when the rotary plate rotates to the second rotation position, the driving member is incapable of driving the sliding member to slide, and incapable of driving the engaging mechanism to be unlocked.

3. The safety seat base according to claim 1, wherein the sliding member comprises a transmission rib protruding into the mounting base, the driving member is provided with a pushing groove, and
wherein when the rotary plate rotates to the first rotation position, the transmission rib is capable of abutting against a groove wall of the pushing groove.

4. The safety seat base according to claim 3, wherein, when the rotary plate rotates to the second rotation position, the transmission rib and the driving member are spaced apart and incapable of contacting each other.

5. The safety seat base according to claim 3, wherein the linkage mechanism further comprises a reinforcing pin, the reinforcing pin being fixedly inserted into the transmission rib.

6. The safety seat base according to claim 1, wherein the linkage mechanism further comprises a linkage member, the linkage member being pivotally connected to the rotary plate, and
wherein when the rotary plate rotates to the first rotation position, the driving member is operable to drive the linkage member to rotate, and the linkage member is rotated to drive the sliding member to slide to drive the engaging mechanism to be unlocked.

7. The safety seat base according to claim 6, wherein the linkage member comprises a first end and a second end, and when the rotary plate rotates to the first rotation position, the first end is capable of abutting against the sliding member, and the second end is capable of abutting against the driving member.

8. The safety seat base according to claim 7, wherein the sliding member is provided with a first pushing groove, the driving member is provided with a second pushing groove, the first end is positioned in the first pushing groove, and
when the rotary plate rotates to the first rotation position, the second end is positioned in the second pushing groove, the first end is capable of abutting against a groove wall of the first pushing groove, and the second end is capable of abutting against a groove wall of the second pushing groove.

9. The safety seat base according to claim 7, wherein, when the rotary plate rotates to the second rotation position, the second end and the driving member are spaced apart and incapable of contacting each other.

10. (canceled)

11. The safety seat base according to claim 1, further comprising an indication mechanism,
wherein the indication mechanism comprises a detector and a sensor, the detector being slidably arranged on the rotary plate, the sensor being arranged on the mounting base, and
wherein the sliding member, when sliding, is capable of pushing the detector to move in a direction intersecting with a sliding direction of the sliding member, so that the detector is sensed by the sensor and outputs information indicating that the rotary plate and the safety seat body are engaged in place; or so that the detector is not sensed by the sensor and outputs information indicating that the rotary plate and the safety seat body are not engaged in place.

12. The safety seat base according to claim 11, wherein the indication mechanism further comprises a controller and a display screen that are arranged on the mounting base, and wherein the sensor is configured to transmit the information indicating that the rotary plate and the safety seat body are engaged in place to the controller, and the controller is configured to display the information indicating that the rotary plate and the safety seat body are engaged in place on the display screen; or
the indication mechanism further comprises a controller arranged on the mounting base, and wherein the sensor is configured to transmit the information indicating that the rotary plate and the safety seat body are engaged in place to the controller, and the controller is configured to transmit the information indicating that the rotary plate and the safety seat body are engaged in place to a mobile terminal.

13. The safety seat base according to claim 11, wherein the indication mechanism further comprises a first reset member, the first reset member being arranged between the detector and the rotary plate, the first reset member always causing the detector to rotate in a direction away from the mounting base.

14. The safety seat base according to claim 11, wherein the sliding member is provided with a push convex protruding in the direction intersecting with the sliding direction of the sliding member, the detector is provided with a push block capable of abutting against the push convex, and
wherein the sliding member, when sliding, pushes the push block to drive the detector to move in the direction intersecting with the sliding direction of the sliding member through the push convex.

15. The safety seat base according to claim 11, wherein the detector is provided with a detection rib, the detection rib being capable of protruding into the mounting base and being detected by the sensor when the detector moves in the direction intersecting with the sliding direction of the sliding member.

16. The safety seat base according to claim 1, wherein the engaging mechanism comprises a locking hook pivotally connected to the rotary plate and having a releasing position and a closed position, the locking hook being configured to be separably engaged with the safety seat body, and the sliding member is capable of holding the locking hook in the closed position.

17. The safety seat base according to claim 16, wherein the linkage mechanism further comprises a second reset member, two ends of the second reset member being connected to the sliding member and the rotary plate respectively, the second reset member always causing the sliding member to move in a direction in which the locking hook is held in the closed position.

18. The safety seat base according to claim 16, wherein the engaging mechanism further comprises a third reset member, two ends of the third reset member abutting against the rotary plate and the locking hook respectively, the third reset member always causing the locking hook to rotate to the releasing position.

19. The safety seat base according to claim 18, wherein the engaging mechanism further comprises a fixed member, a stopper, and a fourth reset member, and
wherein the fixed member is fixedly connected to the locking hook,
one end of the stopper is pivotally connected to the rotary plate, the other end of the stopper is capable of abutting against the fixed member to hold the locking hook at the releasing position, and
two ends of the fourth reset member abuts against the stopper and the rotary plate respectively, and the fourth reset member always causes the stopper to rotate in a direction of abutting against the fixed member.

20. The safety seat base according to claim 1, further comprising an operating assembly,
wherein the operating assembly is connected to the driving member, and the operating assembly is operable to act on the driving member to drive the engaging mechanism to be unlocked.

21-24. (canceled)

25. A safety seat, comprising:
a safety seat body; and
the safety seat base according to claim 1,
wherein the safety seat body is an infant safety seat body or a child safety seat body.

26-48. (canceled)
